(19) United States
(12) Patent Application Publication
(10) Pub. No.: US 2026/0154852 A1
(43) Pub. Date: Jun. 4, 2026

(54) METHOD AND DEVICE FOR ENCODING A SET OF COEFFICIENTS, METHOD AND DEVICE FOR DECODING A SET OF COEFFICIENTS, ASSOCIATED DATA STREAM AND COMPUTER PROGRAM

(71) Applicant: FONDATION B-COM, CESSON-SEVIGNE (FR)

(72) Inventors: Patrick GIOIA, SERVON-SUR-VILAINE (FR); Anas EL RHAMMAD, SAINT-ARMEL (FR); Antonin GILLES, RENNES (FR); San VU NGOC, RENNES (FR)

(21) Appl. No.: 19/124,175

(22) PCT Filed: Oct. 24, 2023
(86) PCT No.: PCT/EP2023/079688

§ 371 Date: Apr. 24, 2025

(30) Foreign Application Priority Data
Oct. 26, 2022 (FR) FR2211126

(51) Int. Cl. G06T 9/00

(52) U.S. Cl. CPC G06T 9/001

(57) ABSTRACT

This relates to a method for encoding coefficients (Wₖ) participating in a representation of a digital hologram by being respectively associated with tuples formed by first and second spatial parameters ang first and second frequency parameters. This method includes the following steps, performed for at least one pair of respective values of the first frequency parameter and the second frequency parameter: encoding data indicative of positions which are associated, respectively, with non-zero coefficients from a set of positions associated, in a predefined manner, with the coefficients which are associated, respectively, with the different tuples defined by the pair of values of the first frequency parameter and the second frequency parameter, and encoding the coefficients which are associated, respectively, with the positions indicated by the indicative data. Also disclosed are a decoding method, encoding and decoding devices, a data stream and a computer program.

### CROSS-REFERENCE TO RELATED APPLICATIONS

This application is the U.S. national phase of International Application No. PCT/EP2023/079688 filed Oct. 24, 2023 which designated the U.S. and claims priority to FR 2211126 filed Oct. 26, 2022, the entire contents of each of which are hereby incorporated by reference.

### BACKGROUND OF THE INVENTION

### Field of the Invention

The present invention relates to the technical field of digital holography.

More particularly, it relates to a method and a device for encoding a set of coefficients participating in a representation of a digital hologram, as well as a method and device for decoding a set of coefficients participating in a representation of a digital hologram, and associated data stream and computer program.

### Description of the Related Art

A digital hologram is the recording in a digital form of a section, at a reference plane, of a light field propagating in a three-dimensional space, in order to be able to subsequently render this light field to a user.

The physical properties of the light fields have led to represent the digital holograms using coefficients respectively associated with elements of a space-frequency domain defined by two spatial dimensions (which correspond to the reference plane) and by the two associated frequency dimensions, i.e. with tuples which are each formed by a first spatial parameter, a second spatial parameter, a first frequency parameter and a second frequency parameter.

### SUMMARY OF THE INVENTION

The invention proposes a method for encoding a set of coefficients participating in a representation of a digital hologram by being respectively associated with tuples which are each formed by a first spatial parameter, a second spatial parameter, a first frequency parameter and a second frequency parameter,
the method comprising the following steps, performed for at least one pair of respective values of the first frequency parameter and the second frequency parameter:
encoding data indicative of positions which are associated, respectively, with non-zero coefficients from a set of positions associated, in a predefined manner, with the coefficients which are associated, respectively, with the different tuples defined by said pair of values of the first frequency parameter and the second frequency parameter;
encoding the coefficients which are associated, respectively, with the positions indicated by said indicative data.

Grouping the coefficients relating to tuples defined by the same pair of frequency parameter values with a view to their encoding makes it possible to encode more localised information, generally at the level of certain coefficients only, and thus to increase the efficiency of the encoding.

According to one possibility, at least one indicative data from said indicative data may represent a difference between a position associated with a non-zero coefficient and another position associated with another non-zero coefficient.

According to another possibility, said indicative data may designate at least one position associated with a non-zero coefficient without designating at least one other position associated with another non-zero coefficient and indicated by indicative data encoded for another pair of respective values of the first frequency parameter and the second frequency parameter. In this way, the position of the non-zero coefficients is encoded relative to those encountered for another pair of values, which increases the efficiency of the encoding.

It may be provided that the coefficients associated with the different tuples defined by said pair of values of the first frequency parameter and the second frequency parameter are ordered in a predefined manner into an ordered sequence of coefficients.

The data indicative of a position associated with a non-zero coefficient may then indicate the position of this non-zero coefficient in said ordered sequence of coefficients, which makes it possible to limit the quantity of data necessary for encoding the positions.

Moreover, it may be provided that, in the coefficient encoding step, the non-zero coefficients are encoded in the order defined by the ordered sequence.

The invention also proposes a method for decoding a set of coefficients participating in a representation of a digital hologram by being respectively associated with tuples which are each formed by a first spatial parameter, a second spatial parameter, a first frequency parameter and a second frequency parameter,
the method comprising the following steps, performed for at least one pair of respective values of the first frequency parameter and the second frequency parameter:
decoding data indicative of positions which are associated, respectively, with non-zero coefficients from a set of positions associated, in a predefined manner, with the coefficients which are associated, respectively, with the different tuples comprising said pair of values of the first frequency parameter and the second frequency parameter;
decoding the coefficients which are associated, respectively, with the positions indicated by said indicative data.

As already indicated for the encoding method, it may be provided that at least one indicative data from said indicative data represents a difference between a position associated with a non-zero coefficient and another position associated with another non-zero coefficient.

According to another possibility, said indicative data may designate at least one position associated with a non-zero coefficient without designating at least one other position associated with another non-zero coefficient and indicated by indicative data decoded for another pair of respective values of the first frequency parameter and the second frequency parameter.

Moreover, the invention proposes a device for encoding a set of coefficients participating in a representation of a digital hologram by being respectively associated with tuples which are each formed by a first spatial parameter, a second spatial parameter, a first frequency parameter and a second frequency parameter, comprising:
a first encoding module designed to encode, for at least one pair of respective values of the first frequency parameter and the second frequency parameter, data indicative of positions which are associated, respectively, with non-zero coefficients from a set of positions associated, in a predefined manner, with the coefficients which are associated, respectively, with the different tuples defined by said pair of values of the first frequency parameter and the second frequency parameter;
a second encoding module designed to encode the coefficients which are associated, respectively, with the positions indicated by said indicative data.

The invention further proposes a device for decoding a set of coefficients participating in a representation of a digital hologram by being respectively associated with tuples which are each formed by a first spatial parameter, a second spatial parameter, a first frequency parameter and a second frequency parameter, comprising:
a first decoding module designed to decode, for at least one pair of respective values of the first frequency parameter and the second frequency parameter, data indicative of positions which are associated, respectively, with non-zero coefficients from a set of positions associated, in a predefined manner, with the coefficients which are associated, respectively, with the different tuples defined by said pair of values of the first frequency parameter and the second frequency parameter;
a second decoding module designed to decode the coefficients which are associated, respectively, with the positions indicated by said indicative data.

The invention also proposes a data stream representing a set of coefficients participating in a representation of a digital hologram by being respectively associated with tuples which are each formed by a first spatial parameter, a second spatial parameter, a first frequency parameter and a second frequency parameter,
the data stream comprising, for at least one pair of respective values of the first frequency parameter and the second frequency parameter:
data indicative of positions which are associated, respectively, with non-zero coefficients from a set of positions associated, in a predefined manner, with the coefficients which are associated, respectively, with the different tuples defined by said pair of values of the first frequency parameter and the second frequency parameter;
data representative of the coefficients which are associated, respectively, with the positions indicated by said indicative data.

The invention further proposes a computer program comprising instructions adapted to implement a method as proposed hereinabove when these instructions are executed by a processor.

The methods proposed hereinabove may thus be implemented by this processor, for example when this processor equips a computer or an encoding or decoding device as mentioned hereinabove and described hereinafter.

The invention finally proposes a computer-readable information medium (for example non-transitory), on which is recorded such a computer program.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 schematically shows a digital hologram;

FIG. 2 shows an example of a digital holographic device;

FIG. 3 shows an example of method implemented by a processing module of the digital holographic device of FIG. 2;

FIG. 4 shows a method for decoding a digital hologram based on data received in a data stream;

FIG. 5 shows an example of an encoding device according to the invention;

FIG. 6 shows an example of a decoding device according to the invention;

FIG. 7 shows a method of exchanging data between the encoding device of FIG. 5 and the decoding device of FIG. 6;

FIG. 8 shows an alternative embodiment of the method of FIG. 7;

FIG. 9 shows a method for partitioning the space-frequency domain D;

FIG. 10 shows a method for encoding coefficients which are associated, respectively, with elements of the space-frequency domain D;

FIG. 11 shows a decoding method corresponding to the encoding method of FIG. 10;

FIG. 12 shows an example of an encoding device in accordance with the teachings of the invention; and

FIG. 13 shows an example of a decoding device in accordance with the teachings of the invention.

### DETAILED DESCRIPTION

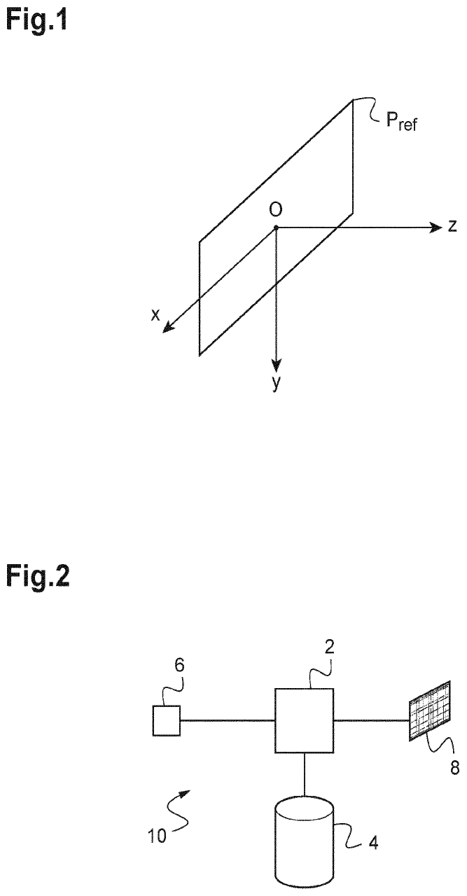

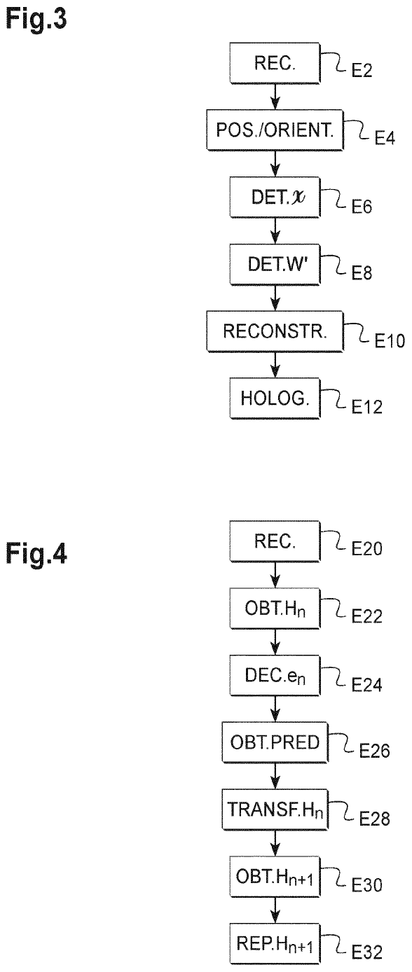

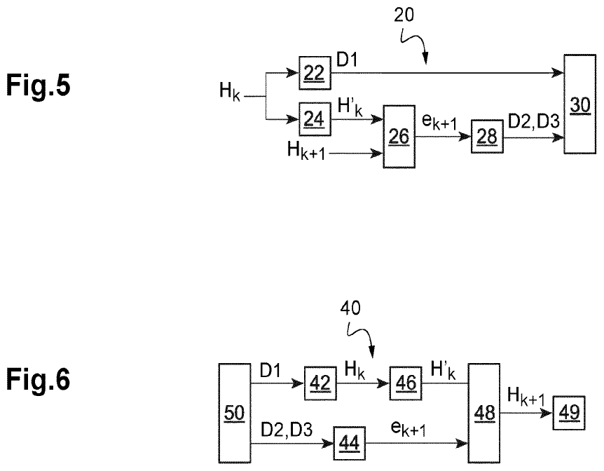

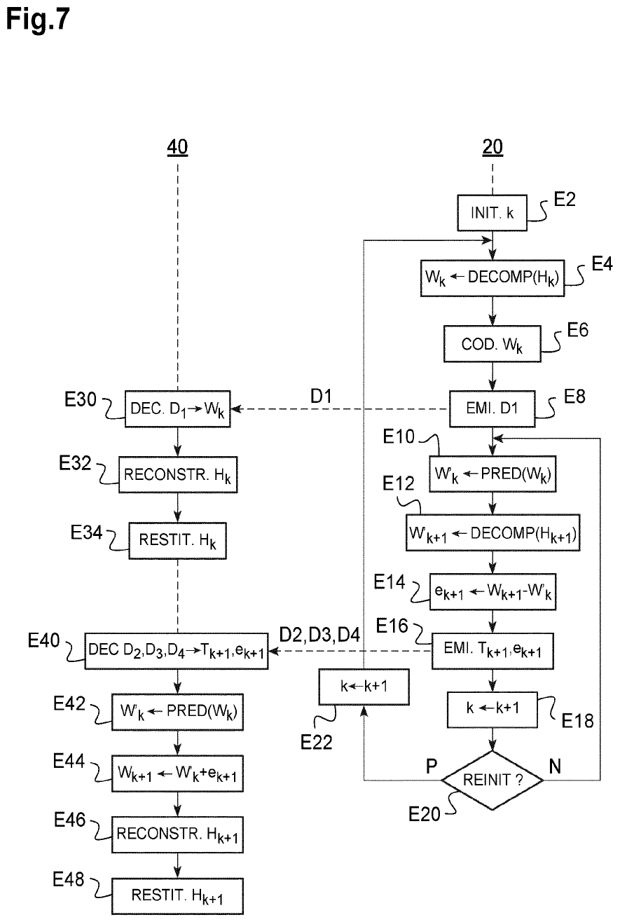

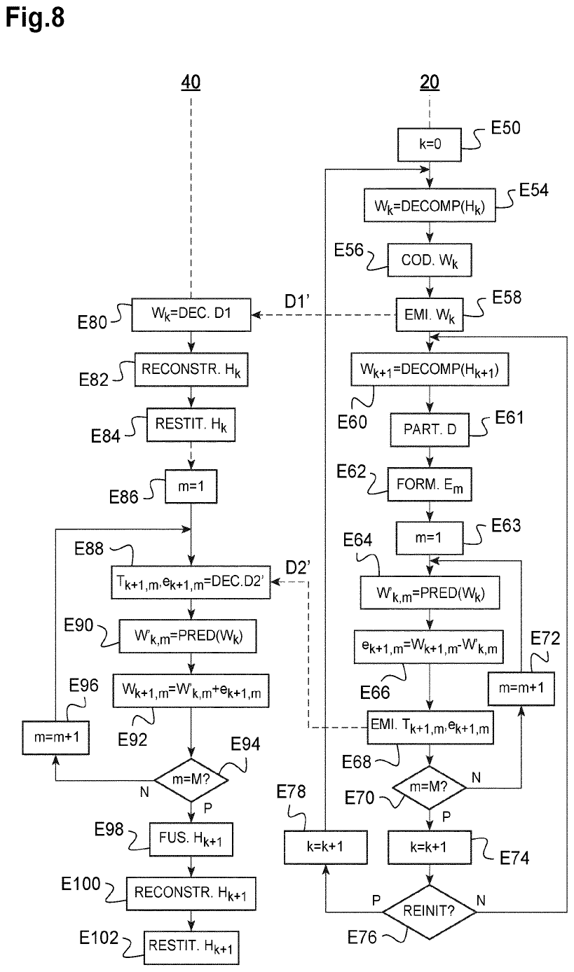

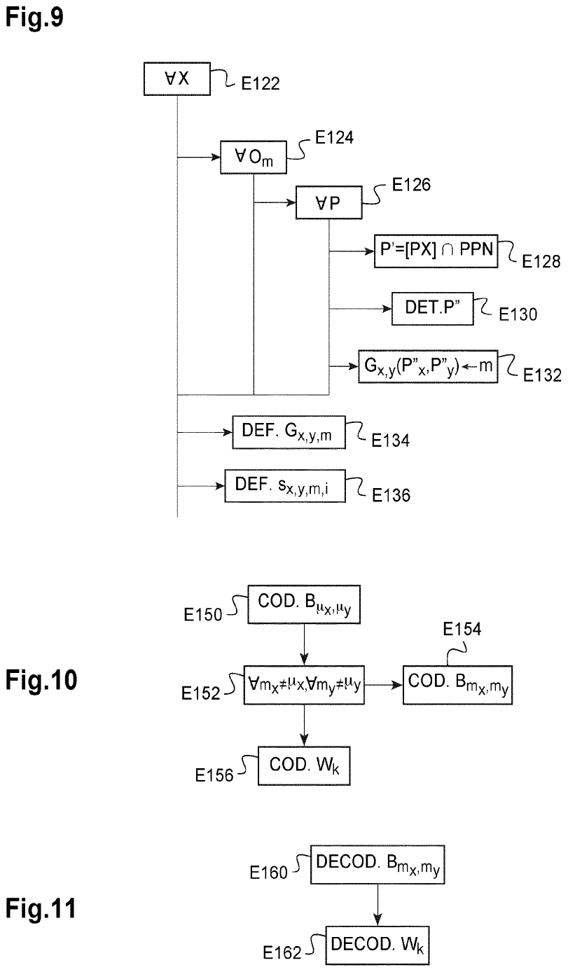

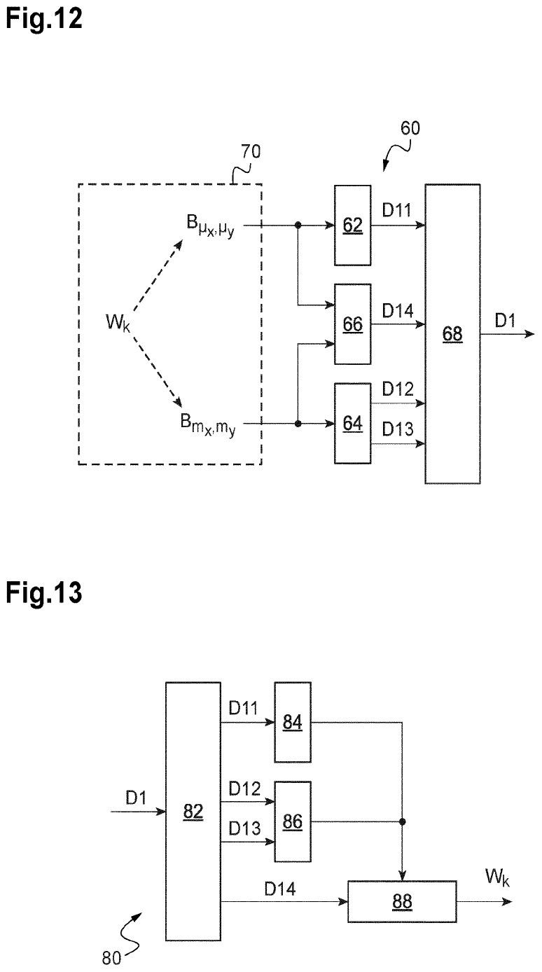

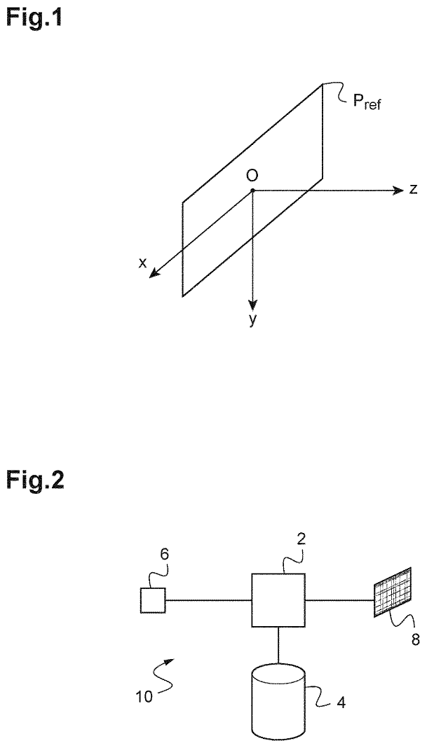

FIG. 1 schematically shows a digital hologram defined by means of a function ψ₀ in a reference plane P_{ref} of equation (z=0) in a space of propagation E where the three-dimensional coordinates of a point are defined in an orthonormal reference frame (O,x,y,z). In other words, axes (Ox) and (Oy) (or more simply axes x and y) are included in the reference plane P_{ref} and/or define the reference plane P_{ref}. The direction of propagation (before application of the transformation mentioned hereinafter) thus here corresponds to axis (Oz); in this situation, the direction of propagation (z) is perpendicular (or orthogonal) to the reference plane P_{ref}.

The wave field (here representing the monochromatic light field of wavelength A) associated with this hologram in one point of the space of propagation E of coordinates r=(x,y,z) is then written (before application of the transformation mentioned hereinafter):

$${ψ}_{z} ( x , y ) = \frac{1}{{λ}^{2}} {\int }_{{D}_{λ}} {e}^{\frac{2 i π}{λ} < r , η >} \hat{{ψ}_{0}} ( {η}_{x} , {η}_{y} ) d {η}_{x} d {η}_{y} \qquad [ Math . 1 ]$$

where the Fourier transform of function ψ₀ is defined (in the reference plane P_{ref}) by

$$\hat{{ψ}_{0}} ( {η}_{x} , {η}_{y} ) = {\int }_{{R}^{2}} {e}^{\frac{- 2 i π}{λ} ( x {η}_{x} + y {η}_{y} )} {ψ}_{0} ( x , y ) dxdy \qquad [ Math . 2 ]$$

λ is the wavelength of the (monochromatic) light concerned, η=(ηₓ, η_{y}, η_{z}) with η_{z}=SQRT(1−ηₓ²−η_{y}²), SQRT( ) being the square root operator, <r,η> is the scalar product of r and η, and D_{λ} is the domain defined by {ηₓ²+η_{y}²<1}.

The wave field defined by the digital hologram may the be seen as a sum (in theory, continuous or infinite) of plane waves of wavelength λ.

In order to take account of the special features of holograms, representations of these holograms are used, which are in the form of a distribution in a 4-dimensional space-frequency domain D (or phase space), the first 2 dimensions of which correspond to the spatial coordinates in plane P of the hologram and the other 2 dimensions correspond to the spatial frequencies in this same plane. Such a distribution comprises for example the light energy values respectively associated with the spatial coordinates and the spatial frequencies of the space-frequency domain D.

According to a first example, a windowed Fourier transform may be applied to the wave field ψ; distribution W_{ψ}^{φ} being then written:

$${W}_{ψ}^{Φ} ( X , Ξ ) = \int {ψ}^{*} ( X + \frac{Y}{2} ) Φ ( X - \frac{Y}{2} ) {e}^{\frac{2 i π Y Ξ}{λ}} dY \qquad [ Math . 3 ]$$

where φ is a so-called window function, ψ* is the (complex) conjugate of ψ, X represents the spatial coordinates (x, y) and Ξ the spatial frequencies (ξₓ, ξ_{y}).

According to a second example, a Wigner-Ville distribution Wψ can be used, which is obtained by applying a Wigner-Ville transform to the wave field ψ:

$${W}_{ψ} ( X , Ξ ) = \int {ψ}^{*} ( X + \frac{Y}{2} ) ψ ( X - \frac{Y}{2} ) {e}^{\frac{2 i π Y Ξ}{λ}} dY \qquad [ Math . 4 ]$$

with, as above, X representing the spatial coordinates (x, y) and Ξ the spatial frequencies (ξₓ, ξ_{y}).

It is therefore a particular windowed Fourier transform, in which the window function that is used is the function ψ.

According to a third example, a decomposition into Gabor frames can be used, which corresponds to a discretisation of the windowed Fourier transform.

For that purpose, a mesh ∧ of the space-frequency domain D is defined as follows:

$$Λ = \{ ( x , y , {ξ}_{x} , {ξ}_{y} ) ∈ {ℝ}^{4} \text{:} ( x , y , {ξ}_{x} , {ξ}_{y} ) = Au , u ∈ {ℤ}^{4} \} \qquad [ Math . 5 ]$$

where A is an invertible matrix of dimensions 4×4.

The decomposition into Gabor frames can then be written:

$$ψ = {\sum }_{ζ ∈ Λ} {W}_{ψ}^{{Φ}^{D}} ( ζ ) \hat{π} ( ζ ) Φ \qquad [ Math . 6 ]$$

where φ^{D} is the dual window of the function φ, π(ζ) is the translation in the space-frequency domain D of vector ζ and with the following modulation/translation operator:

$$\hat{π} ( ζ ) f ( Y ) = {e}^{2 iπ < Y , Ξ >} f ( Y - X ) \qquad [ Math . 7 ]$$

where X, Ξ are the (two-dimensional) spatial component and the (two-dimensional) frequency component, respectively, of the vector ζ, i.e.: ζ=(X, Ξ), and where <, > represents the scalar product (here in the plane).

The field ψτ obtained when a transform T of the three-dimensional space E is applied to the digital hologram will now be studied.

According to Kyoji Matsushima, Hagen Schimmel & Frank Wyrowski, “Fast calculation method for optical diffraction on tilted planes by use of the angular spectrum of plane waves”, in J. Opt. Soc. Am. A 20, 1755-1762 (2003), the wave field (or light field) modified by the transformation T is written as follows (at the level of a plane parallel to the reference plane P_{ref} and of coordinate z):

$${ψ}_{Z}^{T} ( x , y ) = \frac{1}{{λ}^{2}} {\int }_{{D}_{λ}} {e}^{\frac{2 i π}{λ} < r , T η >} ( {η}_{x} , {η}_{y} ) d {η}_{x} d {η}_{y} \qquad [ Math . 8 ]$$

This expression involves in particular the scalar product of the vector of coordinates (x y z)^{t} of the three-dimensional space of propagation E and the vector Tn resulting from the application of the transform T to the wave vector (ηₓ, η_{y}, η_{z}) of predefined norm C and the first two coordinates of which are the frequency variables (ηₓ, η_{y}) respectively associated with the spatial coordinates (x,y) in the reference plane P_{ref} of the digital hologram. The predefined norm C depends on the representation used and is here equal to 1 (normalised representation). As an alternative, the predefined norm could be equal to the wavelength A.

By writing:

$$φ ( r , η ) = < r , T η > , \qquad [ Math . 9 ]$$

the expression of the function ψ_{z}^{τ} given hereinabove can be seen as a Fourier integral operator used in semi-classical analysis in the field of quantum mechanics, where the function φ defined hereinabove is the generating function associated with this operator.

By focusing on a particular plane P_{z} parallel to the reference plane, of coordinate z along the direction perpendicular to the reference plane P_{ref}, the generating function can be written as a four-variable function (i.e. a function with values in [symbol] ⁴) as follows:

$${φ}_{z} ( x , y , {ξ}_{x} , {ξ}_{y} ) = < ( \begin{matrix}x \\ y \\ z\end{matrix} ) , T ( ( \begin{matrix}{ξ}_{x} \\ {ξ}_{y} \\ \sqrt{{C}^{2} - {ξ}_{x}^{2} - {ξ}_{y}^{2}}\end{matrix} ) ) > \qquad [ Math . 10 ]$$

The generating function φ_{z} is thus the scalar product:
of a first vector (of three-dimensional coordinates), the first two coordinates of which correspond to the first two variables among the four variables and the third coordinate of which corresponds to the coordinate z of the plane P_{z} concerned, and
of a vector resulting from the application of the transform T to a second vector, the first two coordinates of which correspond to the last two variables among the four variables and, here, the norm C of which is a predefined constant (this norm C being here equal to 1 due to the above-mentioned normalisation; as an alternative, in other representations, this norm C could for example be equal to the wavelength A).

The explanations are given hereinafter for a given plane P_{z} of coordinate z (plane parallel to the reference plane P_{ref}), but are valid for any plane parallel to the reference plane P_{ref} (i.e. for any z). For the sake of simplification, the generating function φ_{z} associated with this plane P_{z} is hereinafter noted q.

In the context defined hereinabove, if the symplectomorphism of the space-frequency domain D to itself, which corresponds to the transformation T, is noted x, the sub-set (or graph) Γ of [symbol] ⁴× [symbol] ⁴ comprising the elements of the form (e, χ(e)), for e varying in [symbol] ⁴, can also be defined as the set of elements of the form:

$$( x , y , \frac{\partial φ}{\partial x} , \frac{\partial φ}{\partial y} , \frac{\partial φ}{\partial {η}_{u}} , \frac{\partial φ}{\partial {η}_{v}} , {η}_{u} , {η}_{v} ) \qquad [ Math . 11 ]$$

for (x,y, ηᵤ,ηᵥ) varying in [symbol] ⁴.

Reference can be made to “Semi-classical Analysis”, by Victor Guillemin and Shlomo Sternberg, International Press, 2013, ISBN 1571462767, 9781571462763 for more explanations on that subject.

It is reminded that a symplectomorphism is a diffeomorphism which retains the symplectic form, i.e. whose Jacobian matrix M verifies: J=M^{t}JM,
with:

$$J = [ \begin{matrix}0 & 0 & 1 & 0 \\ 0 & 0 & 0 & 1 \\ - 1 & 0 & 0 & 0 \\ 0 & - 1 & 0 & 0\end{matrix} ] \qquad [ Math . 12 ]$$

$$By noting$$

$${σ}_{x , y} ( {η}_{u} , {η}_{v} ) = ( \frac{\partial φ}{\partial x} ( x , y , {η}_{u} , {η}_{v} ) , \frac{\partial φ}{\partial y} ( x , y , {η}_{u} , {η}_{v} ) ) \qquad [ Math . 13 ]$$

the expression of the variables ηᵤ and ηᵥ can be given as a function of e=(x,y,ξₓ,ξ_{y}):

$$( {η}_{u} , {η}_{v} ) = {σ}_{x , y}^{- 1} ( {ξ}_{x} , {ξ}_{y} ) \qquad [ Math . 14 ]$$

The 5^{th} and 6^{th} coordinates (u, v) of the elements of the sub-set Γ can thus be written:

$$( u , v ) = ( \frac{\partial φ}{\partial {η}_{u}} ( x , y , {σ}_{x y}^{- 1} ( x , y , {ξ}_{x} , {ξ}_{y} ) ) , \frac{\partial φ}{\partial {η}_{v}} ( x , y , {σ}_{x y}^{- 1} ( x , y , {ξ}_{x} , {ξ}_{y} ) ) ) \qquad [ Math . 15 ]$$

A parametric expression of the sub-set Γ as a function of its first four coordinates (x,y,ξₓ,ξ_{y}) is thus obtained, which makes it possible to obtain the following expression of the symplectomorphism χ (it being reminded that the sub-set I corresponds to the elements of the form (e, χ(e)) for e varying R⁴):

$$χ ( x , y , {ξ}_{x} , {ξ}_{y} ) = ( \frac{\partial φ}{\partial {η}_{u}} ( x , y , {σ}_{x y}^{- 1} ( x , y , {ξ}_{x} , {ξ}_{y} ) ) , \frac{\partial φ}{\partial {η}_{v}} ( x , y , {σ}_{x y}^{- 1} ( x , y , {ξ}_{x} , {ξ}_{y} ) ) , {σ}_{x y}^{- 1} ( x , y , {ξ}_{x} , {ξ}_{y} ) ) \qquad [ Math . 16 ]$$

Considering now that the transformation T studied is a rigid transformation of the space of propagation E, this transformation T is therefore the combination of a translation of vector (tₓ,t_{y},t_{z}) and a rotation R that may be decomposed into 3 rotations using Euler angles: R=R^{z}_{α}R^{x}_{θ}R^{z}_{β},
where R^{z}_{α} and R^{z}_{β} are rotations about axis z of respective angles α and β, and R^{x}_{θ} is a rotation of angle θ about axis x.

Symplectomorphisms λₜ, λ_{α}, λ_{θ}, λ_{β} can thus be defined, which are respectively associated with the translation and these 3 rotations R^{z}_{α}, R^{x}_{θ}, R^{z}_{β}, and whose composition is the symplectomorphism χ associated with the transformation T:
χ=χβ o χ_{θ} o χ_{α} o χₜ, where o is the composition operator.

Symplectomorphism χₜ, χ_{α}, χ_{β} associated with the translation and the rotations R^{z}₊, R^{x}_{θ}, R^{z}_{β} about axis Z are simply written:

$${X}_{t} ( x , y , {ξ}_{x} , {ξ}_{y} ) = ( x + {t}_{x} , y + {t}_{y} , {ξ}_{x} , {ξ}_{y} )$$

$${X}_{α} ( x , y , {ξ}_{x} , {ξ}_{y} ) = ( x \cdot cos α - y \cdot sin α , x \cdot sin α + y \cdot cos α , {ξ}_{x} \cdot cos α - {ξ}_{y} \cdot sin α , {ξ}_{x} \cdot sin α + {ξ}_{y} \cdot cos α )$$

$${X}_{β} ( x , y , {ξ}_{x} , {ξ}_{y} ) = ( x \cdot cos β - y \cdot sin β , x \cdot sin β + y \cdot cos β , {ξ}_{x} \cdot cos β - {ξ}_{y} \cdot sin β , {ξ}_{x} \cdot sin β + {ξ}_{y} \cdot cos β )$$

It is noted that the third component t_{z} of the translation is taken into account in the propagation, i.e. considering the plane P_{z+tz}.

It is proposed to use the developments exposed hereinabove to determine the symplectomorphism χ_{θ} associated with the rotation R^{x}_{θ} of angle θ about axis x.

In this case, the generating function q is written:

$$φ ( r , η ) = < r , {R}_{θ}^{x} η > = ( x y z ) ( \begin{matrix}1 & 0 & 0 \\ 0 & cos θ & - sin θ \\ 0 & sin θ & cos θ\end{matrix} ) {( {η}_{x} {η}_{y} {η}_{z} )}^{t} \qquad [ Math . 17 ]$$

$$i . e . :$$

$$φ ( r , η ) = x \cdot {η}_{x} + y \cdot ( {η}_{y} \cdot cos θ - {η}_{z} \cdot sin θ ) + z \cdot ( {η}_{y} \cdot sin θ + {η}_{z} \cdot cos θ ) \qquad [ Math . 18 ]$$

Using the fact that:

$$( {ξ}_{x} , {ξ}_{y} ) = ( \frac{\partial φ}{\partial x} , \frac{\partial φ}{\partial y} ) \qquad [ Math . 19 ]$$

(see above the definition of the sub-set Γ) and by replacing η_{z} by its expression as a function of ηₓ and η_{y} given hereinabove, we obtain:

$${ξ}_{x} = {η}_{x}$$

$${ξ}_{y} = ( {η}_{y} \cdot cos θ ) - SQRT ( 1 - {η}_{x}^{2} - {η}_{y}^{2} ) \cdot sin θ$$

By taking the square of the two terms of this equation, we obtain a second-degree equation whose only physically meaningful solution is:

$${η}_{y} = ( {ξ}_{y} \cdot cos θ ) - SQRT ( 1 - {η}_{x}^{2} - {η}_{y}^{2} ) \cdot sin θ$$

Using again the definition of the sub-set Γ, the expression of the symplectomorphism χ_{θ} can be finalised as follows:

$${X}_{θ} ( x , y , {ξ}_{x} , {ξ}_{y} ) = ( U , V , {ξ}_{x} , ( {ξ}_{y} \cdot cos θ ) + SQRT ( 1 - {ξ}_{x}^{2} - {ξ}_{y}^{2} ) \cdot sin θ with$$

$$U = \frac{\partial φ}{\partial {η}_{x}} = x - ( y \cdot sin θ - z \cdot cos θ ) \frac{( - {η}_{x} )}{\sqrt{1 - {η}_{x}^{2} - {η}_{y}^{2}}} \qquad [ Math . 20 ]$$

$$V = \frac{\partial φ}{\partial {η}_{y}} = y \cdot ( cos θ - sin θ \frac{( - {η}_{y} )}{\sqrt{1 - {η}_{x}^{2} - {η}_{y}^{2}}} ) + z \cdot ( sin θ + cos θ \frac{( - {η}_{y} )}{\sqrt{1 - {η}_{x}^{2} - {η}_{y}^{2}}} ) \qquad [ Math . 21 ]$$

It is to be noted that the variables ηₓ and η_{y} in the latter expressions are expressed as a function of ξₓ and ξ_{y} a few lines above.

We are now interested in the consequences of the transformation T of the three-dimensional propagation space E on the representation W_{ψ}^{φ}, W_{ψ} of the digital hologram (also referred to as the distribution).

The representations W_{ψ}^{φ}, W_{ψ} of the hologram in the space-frequency domain D can be seen as the symbol P of a pseudo-differential operator Op (P). By continuing the parallel with the quantum mechanic theories, reference can be made to the article “How Wigner Functions Transform Under Symplectic Maps”, de Alex J. Dragt and Salman Habib, in Proceedings of the Advanced Beam Dynamics Workshop on Quantum Aspects of Beam Physics (Monterey, CA) 1998.

In the first example given hereinabove (windowed Fourier transform), the differential operator of symbol W_{ψ}^{φ} is

$$O p ( {W}_{Ψ}^{Φ} ) = \vert Φ \text{><} Ψ \vert$$

where we use the usual quantum mechanics notation introduced in the article “A new notation for quantum mechanics”, de P. A. M. Dirac, in Mathematical Proceedings of the Cambridge Philosophical Society, July 1939, p. 416-418.

In the second example (Wigner-Ville distribution), the differential operator of symbol Wų is:

$$O p ( {W}_{Ψ} ) = \vert Ψ \text{><} Ψ \vert .$$

As regards the third example (Gabor frames), it can be observed that the decomposition uses functions of the same type as that used in the first example (windowed Fourier transform), in a sum on the elements of the mesh, and the developments hereinafter thus apply due to the fact that they apply to the different terms of the sum.

By continuing the parallel with the theories of the semi-classical analysis (reference can be for example to the article “Uniform semiclassical estimates for the propagation of quantum observables” by A. Bouzouina and D. Robert in Duke Mathematical Journal, 111 (2) 223-252, Feb. 1, 2002), the effects of the transformation T on the hologram can the be rendered by applying the propagation operator Op(χ) (associated with the symplectomorphism x) to the pseudo-differential operator Op(P) so that the symbol P′ of the propagated differential operator Op(χ)Op(P)[Op(χ)]⁻¹ forms a representation of the hologram resulting from the transformation T.

According to Egorov's theorem (see for example the above-mentioned article of A. Bouzouina and D. Robert), the symbol P′ of the propagated differential operator Op(χ)Op(P)[Op(χ)]⁻¹ may be written:

$${P}^{′} = P ( χ ) + {\sum }_{n \geq 1} {λ}^{n} . {f}_{n} \qquad [ Math . 22 ]$$

where χ is the symplectomorphism associated with the transformation T as explained hereinabove, λ is the wavelength of the light concerned, as already mentioned, and where the functions fₙ are defined as a sum of integrals of bi-differential differential operators; for example, in the Weyl quantification used, the function f₁ is zero and the functions fₙ can be defined as follows for n>1:

$${f}_{n} = {\sum }_{l = 0}^{n - 2} {( \frac{i}{2} )}^{n - 2 l} {\int }_{0}^{z} {\{ {H}_{t} , Po {χ}_{t} \}}_{n + 1 - l} o {χ}_{z - t} d t \qquad [ Math . 23 ]$$

where Hₜ and χₜ are the Hamiltonian and the Hamiltonian flow, respectively, at time t (see above), i is here as above the imaginary number such that i²=−1, and where the extended Poisson's bracket is defined as follows:

$${\{ g , h \}}_{k} = {\sum }_{\vert a + b \vert = k} \frac{{( - 1 )}^{\vert b \vert}}{a ! b !} {\partial }_{q}^{a} {\partial }_{p}^{b} h {\partial }_{q}^{b} {\partial }_{p}^{a} g \qquad [ Math . 24 ]$$

where g and h are scalar functions of (q, p) over the space-frequency domain D.

Therefore, when the generating function q is non-quadratic, i.e. the symplectomorphism χ is non-linear as explained in the above-mentioned article “How Wigner Functions Transform Under Symplectic Maps”, the representation P′ of the hologram deformed by the transformation T does not limit to a deformation of the space-frequency domain D by means of the symplectomorphism χ (term P(χ) in the above formula), but comprises additional corrective terms that each depend on the wavelength λ, precisely, which each include a factor equal to a power of the wavelength λ. In practice, as indicated hereinafter, a single additional corrective term can be used, that includes a factor equal to the wavelength λ or, here, equal to the square λ² of the wavelength λ.

The Hamiltonian Hₜ and the Hamiltonian flow χₜ are linked by the Hamilton equations:

$$\frac{\partial }{\partial t} {χ}_{t} = ( \begin{matrix}\frac{\partial }{\partial q} {H}_{t} \\ - \frac{\partial }{\partial p} {H}_{t}\end{matrix} ) \qquad [ Math . 25 ]$$

In practice, the Hamiltonian flow χₜ can be decomposed into two Hamiltonian flows respectively linked to a translation and a rotation, and thus it is possible to consider a Hamiltonian H^{trans} linked to translation and a Hamiltonian H^{rot} linked to rotation.

The translational Hamiltonian H^{trans} corresponds simply to the free propagation in a homogeneous medium of refractive index no (in practice, we can take n₀=1 for propagation in the air): H^{trans}=SQRT(n₀²−|p|²).

As regards the rotational Hamiltonian H^{rot}, the expression of its derivatives (which are the only ones needed to evaluate the functions fₙ defined hereinabove) can be obtained, by reporting the literal expression of the symplectomorphism χ_{θ} in the Hamiltonian formulas described hereinabove:

$$\frac{\partial {H}^{r o t}}{\partial {ξ}_{x}} = \frac{\partial U}{\partial θ} = y . cos θ \frac{{ξ}_{x}}{R} + y . sin θ \frac{{ξ}_{x} ( {ξ}_{y} . sin θ - R . cos θ )}{{[ 1 - {ξ}_{x} - ( {ξ}_{y} . cos θ + R . sin θ ) ]}^{\frac{3}{2}}} \qquad [ Math . 26 ]$$

$$\frac{\partial {H}^{r o t}}{\partial {ξ}_{y}} = \frac{\partial V}{\partial θ} = - y . sin θ - \frac{\partial {η}_{z}}{\partial {η}_{y}} cos θ - sin θ {\partial }_{θ} \frac{{η}_{y}}{\sqrt{1 - {η}_{x}^{2} - {η}_{y}^{2}}} \qquad [ Math . 27 ]$$

$$\frac{\partial {H}^{r o t}}{\partial x} = - \frac{\partial {η}_{x}}{\partial θ} = 0 \qquad [ Math . 28 ]$$

$$\frac{\partial {H}^{r o t}}{\partial y} = - \frac{\partial {η}_{y}}{\partial θ} = {ξ}_{y} . sin θ - R . cos θ \qquad [ Math . 29 ]$$

with R=SQRT(1−ξₓ²−ξ_{y}²).

The derivative of higher order can be obtained on this basis by numerical methods (such as the finite difference method).

FIG. 2 shows an example of a digital holography device 10 using the teachings of the invention.

This digital holography device 10 comprises a processing module 2, a storage module 4, an acquisition module 6 and a holographic rendering module 8.

The digital holography device 10 is for example made in the form of a headset or augmented reality glasses.

The processing module 2 is for example a processor, here a microprocessor.

The acquisition module 6 comprises at least one motion sensor (for example of the accelerometer or gyroscope type) that transmits measurement signals (in analogue or digital form) to the processing module 2, on the basis of which the processing module 2 can elaborate data representative of the position and/or the orientation of the digital holography device 10.

The storage module 4 comprises for example a memory and/or a hard disk.

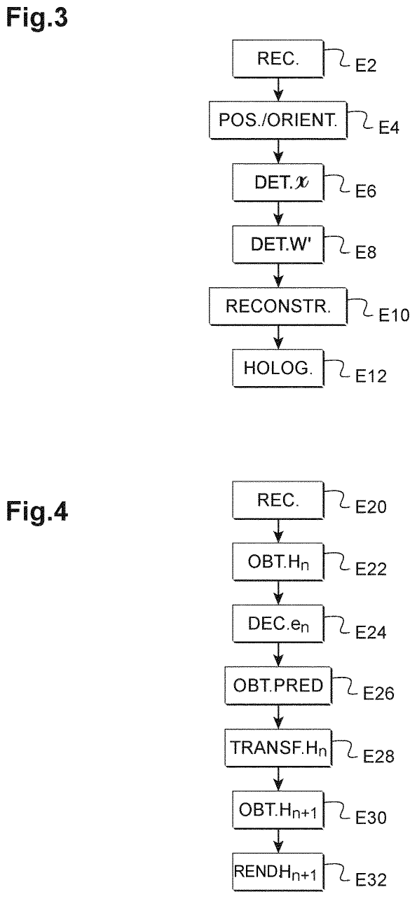

The storage module 4 stores in particular computer program instructions designed in such a way that the processing module 2 implements some at least of the steps of the method described hereinafter with reference to FIG. 3 when these instructions are executed by the processing module 2.

As explained hereinafter, the storage module 4 further stores a representation W of a digital hologram in the already mentioned space-frequency domain D. In practice, the storage module stores values W(L) respectively associated with different elements L of the space-frequency domain D (i.e. in practice with different elements of R⁴).

The holographic rendering module 8 here comprises a light modulator and a light source of wavelength A, and enables the rendering of the digital hologram represented by the representation W to a user. Reference can be made to the patent application published as WO2019/001968 on this subject.

FIG. 3 shows an example of method implemented by the processing module 2 of the digital holographic device of FIG. 10.

This method starts by a step E2 of receiving measurement signals from the acquisition module 6.

The processing module 2 then determines data representative of the position and/or the orientation of the digital holography device 10 based on the measurement signals received (step E4).

In order to display the digital hologram to the user by taking account of the movement of the digital holography device 10 (and to thus simulate the reciprocal movement of the digital hologram in relation to the user), the processing module 2 applies to the digital hologram (represented by the representation W as mentioned hereinabove) a transformation T defined in the three-dimensional space of propagation E as a function of the above-mentioned representative data.

For that purpose, the processing module 2 determines, in step E6, the symplectomorphism χ associated with this transformation T thanks to the method proposed hereinabove. As already indicated, in a plane P_{z} parallel to the reference plane P_{ref}, the function χ (symplectomorphism) is such that the sub-set of the elements of the product space D×D of the form (e, χ(e)) is the sub-set defined by the elements of the form (x, y

$$\frac{\partial φ}{\partial x} , \frac{\partial φ}{\partial y} , \frac{\partial φ}{\partial {η}_{x}} , \frac{\partial φ}{\partial {η}_{y}} ,$$

ηₓ, η_{y}) for (x, y, ηₓ, η_{y}) varying in [symbol] ⁴, where φ is a four-variable non-quadratic generating function defined as a scalar product of:
a first vector, the first two coordinates of which correspond, respectively, to the first two variables among the four variables and the third coordinate of which corresponds to the coordinate of said parallel plane P_{z} along the direction z perpendicular to the plane of reference P_{ref}, and
a vector resulting from the application of the transformation to a second vector, the first two coordinates of which correspond respectively to the last two variables among the four variables and the norm of which is defined here.

The processing module can thus determine, in step E8, the representation W′ of the transformed digital hologram (or digital hologram modified by application of the transformation T) on the basis of the representation W stored in the storage module 4 and the function χ (symplectomorphism) determined in step E6. As an alternative, the representation W (i.e. in practice data representative of the above-mentioned values W(L)) could be received by the digital holography device 10 by means of a communication module (not shown).

In accordance with what has been exposed hereinabove, the representation W′ of the transformed digital hologram can be determined as follows:

$${W}^{′} ( L ) = Wo χ ( L ) + {\sum }_{1 \leq n \leq N} {λ}^{n} . {f}_{n} ( L ) \qquad [ Math . 30 ]$$

for the different L of the space-frequency domain D used in the representation concerned, where N is a predetermined value for a given digital holography device (which corresponds to the desired degree of accuracy), λ is, as already indicated, the wavelength associated with (and thus used to render) the digital hologram, o is as already indicated the composition operator and where the functions fₙ are defined hereinabove.

In practice, it is possible to use only the first non-zero term (called “corrective term”) of the sum in the above formula; the processing module determines in this case the representation W′ of the modified digital hologram as follows (the factor f₁ being zero with the Weyl quantification used here):

$${W}^{′} ( L ) = Wo χ ( L ) + {λ}^{2} . {f}_{2} ( L ) \qquad [ Math . 31 ]$$

$$with$$

$${f}_{2} = - \frac{1}{4} {\int }_{0}^{z} {\{ {H}_{t} , Wo {χ}_{t} \}}_{3} o {χ}_{z - t} d t \qquad [ Math . 32 ]$$

where {.}₃ is the Poisson's bracket defined hereinabove.

The processing module 2 is therefore designed to apply the function χ when the transformation T is applied to the digital hologram. The function χ is applied in particular during the composition of this function with the representation W(term W o χ).

Moreover, as indicated hereinabove, it is provided here that the distribution W′ representing the digital hologram transformed by the transformation T is determined by the processing module 2 using at least one corrective term that depends on the wavelength λ. This corrective term is non-zero due to the fact that the function χ is non-linear (the generating function φ being non-quadratic as explained hereinabove).

The processing module 2 can then control the rendering of the transformed digital hologram (represented by the representation or distribution W′) by means of the holographic rendering module 8.

For the purpose, the processing module 2 reconstructs for example, in step E10, the transformed digital hologram from the representation W′ obtained in step E8. The reconstruction step may comprise in practice a summation of the light contributions respectively associated with the values W′(L) defining the representation W′ for the different elements L of the space-frequency domain D.

The processing module 2 then sends to step E12 signals representative of the reconstructed digital hologram to the holographic rendering module 8 (in practice, to the light modulator equipping this holographic rendering module 8) in order to allow the rendering of the transformed digital hologram to the user, here by illuminating, with the light source of wavelength λ, the light modulator configured based on the signals representative of the reconstructed digital hologram.

As an alternative, the rendering of step E12 could be made on a stereoscopic system. Step E12 then comprises a sub-step of stereoscopic conversion to convert the reconstructed hologram into stereoscopic signals and a sub-step of displaying on a screen of the stereoscopic system from stereoscopic signals.

FIG. 4 shows a method implemented in another context of use of the invention. It is a method for decoding a digital hologram Hₙ₊₁ based on data received in a data stream.

This method is implemented in a decoding device. Such a decoding device comprises for example a processor and a memory storing computer program instructions designed to implement some steps at least of the method of FIG. 4 when these instructions are executed by the processor.

This decoding device can be a computer (for example, a personal computer) or a digital holography device as described hereinabove with reference to FIG. 2.

The method of FIG. 4 starts with a step E20 of receiving a data stream. The decoding device receives for example this data stream from a remote server, typically by means of a communication module of the decoding device.

The method continues with a step E22 of obtaining a reference digital hologram Hₙ. The decoding device can obtain the reference digital hologram by decoding data received in the above-mentioned data stream. These data are for example representative of a representation Wₙ of the digital hologram Hₙ (without reference to another digital hologram). As an alternative, the digital hologram Hₙ can be obtained by means of a method of the same type as that described here to obtain the digital hologram Hₙ₊₁.

The method also comprises a step E24 of decoding a residue eₙ from other data received in the data stream.

The method also comprises a step E26 of obtaining a predictor PRED, for example by reading in a memory of the decoding device. As an alternative, the predictor PRED can be obtained by decoding the data contained in the data stream received.

The method then comprises a step E28 of predicting a predicted digital hologram H′ₙ by applying to the reference digital hologram Hₙ a transformation T defined by the predictor PRED, using the techniques described hereinabove to transform the representation P into representation P′, which thus comprise the application of a function χ determined as described hereinabove.

As in the framework of the method of FIG. 3, the reference digital hologram Hₙ is for example represented by a representation W in the space-frequency domain D (i.e. by values W(L) respectively associated with different elements L of the space-frequency domain D).

In this case, the prediction step E28 can include a determination of a distribution W′ representing the predicted digital hologram H′ₙ on the basis of the representation W of the reference digital hologram Hₙ in accordance with what has been exposed hereinabove for step E8 of FIG. 3, i.e. as follows:

$${W}^{′} ( L ) = Wo χ ( L ) + {\sum }_{1 \leq n \leq N} {λ}^{n} . {f}_{n} ( L ) \qquad [ Math . 33 ]$$

for the different L of the space-frequency domain D used in the representation concerned, where N is a predetermined value for a given decoding device (which corresponds to the desired degree of accuracy, with for example N=1, in which case the formula contains a single corrective term λ·fₙ(L)), λ is, as already indicated, the wavelength associated with the digital holograms, o is as already indicated the composition operator and where the functions fₙ are defined hereinabove.

The function χ is therefore applied in particular during the composition of this function with the representation W(term W o x).

Moreover, as indicated hereinabove, it is provided here that the distribution (or representation) W′ representing the predicted digital hologram H′ₙ is determined by the decoding device using at least one corrective term that depends on the wavelength λ. This corrective term is non-zero due to the fact that the function χ is non-linear, as explained hereinabove.

The method can then comprise a step E30 for obtaining the decoded hologram Hₙ₊₁ by combination of the residue eₙ and of the predicted digital hologram H′ₙ.

For example, for the different L of the space-frequency domain D used in the representation concerned, the representation (or distribution) W″ representing the decoded digital hologram Hₙ₊₁ is obtained as follows:

$${W}^{″} ( L ) = {W}^{′} ( L ) + E ( L )$$

where E is the representation of the residue eₙ in the space-frequency domain D.

When the decoding device comprises a holographic rendering module (for example, when the decoding device is a digital holography device as that of FIG. 2), the method can further comprise a step of reconstructing the hologram to be rendered on the basis of the representation W″ of the decoded hologram Hₙ₊₁ and/or a step E32 of rendering the decoded (and reconstructed) digital hologram by means of the holographic rendering module.

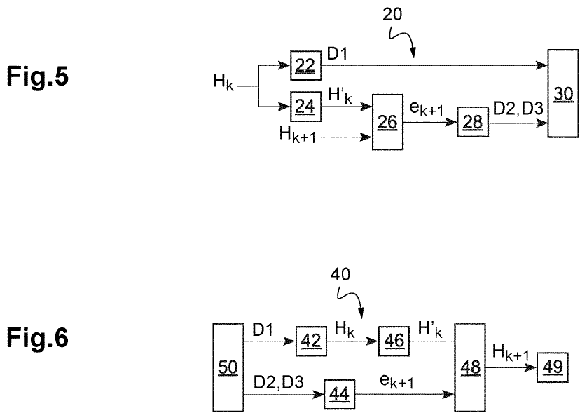

FIG. 5 shows an example of an encoding device 20 according to the invention.

This encoding device is for example located within a server so as to provide data representative of a sequence of digital holograms to a client electronic device, as described in the following.

The encoding device 20 here comprises a first encoding unit 22, a prediction unit 24, a residue determination unit 26, a second encoding unit 28 and a communication unit 30.

The encoding device 20 is for example made in the form of an electronic device comprising a processor (such as a microprocessor); in this case, each of the above-mentioned units can be implemented due to the execution, by this processor, of computer program instructions stored within the electronic device forming the encoding device 20 (for example, in a memory of this electronic device). However, as an alternative, one at least of the above-mentioned units can be made by means of a dedicated electronic circuit, for example an application specific integrated circuit.

The first encoding unit 22 is designed to produce data D1 which are representative of a digital hologram Hₖ, here a reference digital hologram, without reference to data relating to another digital hologram. Referring to FIG. 10, an example of a possible implementation of the encoding performed by the first coding unit 22 is described hereinafter.

The prediction unit 24 is designed to predict a digital hologram H′ₖ, called the “predicted digital hologram”, by transformation of the reference digital hologram Hₖ, using the techniques that have been presented hereinabove with reference to FIGS. 1 to 4, in particular by applying the function χ defined hereinabove for determining the predicted digital hologram.

The residue determination unit 26 is designed to determine a residue eₖ₊₁ between the predicted digital hologram H′ₖ produced by the prediction unit 24 and the current digital hologram H_{k+1.}

The second encoding unit 28 is designed to produce data D3, D4 representative of the residue eₖ₊₁ produced by the residue determination unit 26.

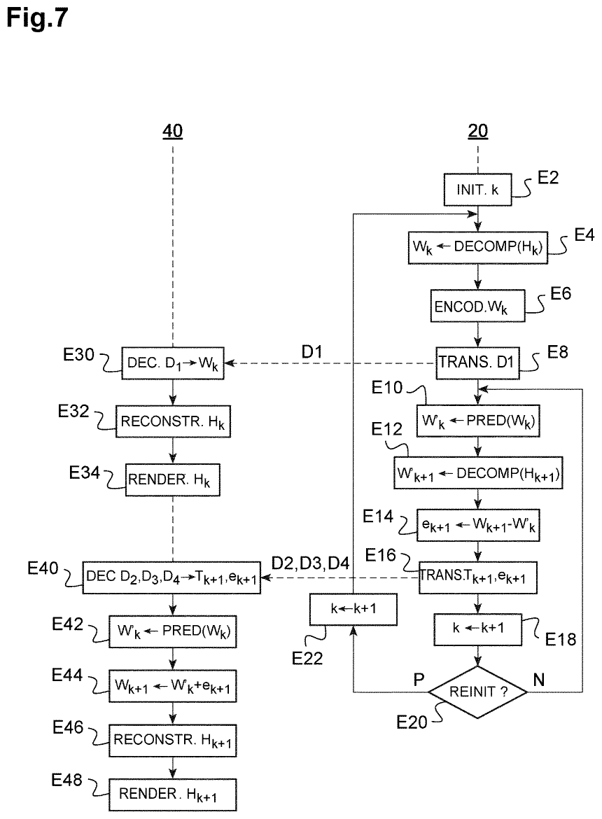

Complementary elements relating to the operation of these different units are given hereinafter with reference in particular to FIG. 7.

Finally, the communication unit 30 is designed to transmit the representative data produced by the first encoding unit 22 and/or by the second encoding unit 28 to the client electronic device.

FIG. 6 shows an example of a decoding device 40 according to the invention.

This decoding device 40 is for example an electronic device (such as the above-mentioned client electronic device) designed to receive data representative of a sequence of digital holograms from a server (such as the above-mentioned server).

The decoding device 40 comprises a first decoding unit 42, a second decoding unit 44, a prediction unit 46, a combination unit 48, a reconstruction unit 49 and a communication unit 50.

The decoding device 40 is for example made in the form of an electronic device comprising a processor (such as a microprocessor); in this case, each of the above-mentioned units can be implemented due to the execution, by this processor, of computer program instructions stored within the electronic device forming the decoding device 40 (for example, in a memory of this electronic device). However, as an alternative, one at least of the above-mentioned units can be made by means of a dedicated electronic circuit, for example an application specific integrated circuit.

The first decoding unit 42 is designed to obtain a digital hologram Hₖ, here a reference digital hologram, from data D1 representative of this digital hologram. These representative data D1 are for example received by the communication unit 50 (from the encoding device 20 in the examples described hereinafter). An example of decoding method that can be implemented by the first decoding unit is described hereinafter with reference to FIG. 11.

The second decoding unit 44 is designed to decode a residue eₖ₊₁ from data D3, D4 representative of this residue eₖ₊₁. These data D3, D4 representative of the residue are here received by the communication unit 50 (for example, from the encoding device 20).

The prediction unit 46 is designed to predict a digital hologram H′ₖ, called the “predicted digital hologram”, by transformation of the reference digital hologram Hₖ, using the techniques that have been presented hereinabove with reference to FIGS. 1 to 4, in particular by applying the function χ defined hereinabove for determining the predicted digital hologram. Its operation is similar to that of the prediction unit 24 of the encoding device 20.

The combination unit 48 is designed to obtain a digital hologram Hₖ₊₁ (called the “decoded digital hologram”) by combination of the residue eₖ₊₁ decoded by the second decoding unit 44, and the predicted hologram H′ₖ produced at the output of the prediction unit 46.

The reconstruction unit 49 is designed to reconstruct the decoded digital hologram Hₖ₊₁ based on a representation of this digital hologram, this representation here using a decomposition into Gabor frames.

Complementary elements relating to the operation of these different units are given hereinafter with reference in particular to FIG. 7.

FIG. 7 represents a method for data exchange between the encoding device 20 and the decoding device 40 with a view, for example, to render, on a holographic rendering device, a sequence of digital holograms encoded by the encoding device 20, transmitted from the encoding device 20 to the decoding device 40 (for example, via a communication network), and decoded by the decoding device 40.

This method starts with a step E2 of initialising the index k that designates the current digital hologram Hₖ in the sequence of digital holograms that is processed. Index k is here initialised to 0.

The method continues with a step E4 of decomposing the current digital hologram Hₖ into Gabor frames Wₖ. As mentioned hereinabove, the current digital hologram Hₖ is then represented by a set of first coefficients (here complex) Wₖ(ζ) respectively associated with elements ζ of the space-frequency domain D. It is reminded that each of these elements of the space-frequency domain D is formed by a first spatial parameter x, a second spatial parameter y, a first frequency parameter n and a second frequency parameter ξ.

The coefficients Wₖ(ζ) can for example be calculated by the following formula:

$${W}_{k} ( ζ ) = < \hat{π} ( ζ ) {Φ}^{D} , {H}_{k} >$$

using the notation from the formula [Math. 6] above and where <f, g> is the scalar product between the functions f and g.

In practice, the representation of the current digital hologram Hₖ that is used is for example a sparse representation, i.e. the coefficients Wₖ(ζ) are chosen to represent at best the current digital hologram Hₖ while being limited in number. For that purpose, a “basis pursuit” algorithm is used to select the coefficients Wₖ(ζ) taken from the decomposition of the current digital hologram Hₖ into Gabor frames to be used in the sparse representation. Reference can be made, for example, to the article “Basis pursuit”, by S. Chen and D. Donoho in Proceedings of 1994 28th Asilomar Conference on Signals, Systems and Computers (vol. 1, pp. 41-44), October 1994, as regard the basis pursuit algorithm.

The method of FIG. 7 then continues with a step E6 of encoding the current digital hologram Hₖ, i.e. here encoding the coefficients Wₖ(ζ) representing the current digital hologram Hₖ. This encoding step is here carried out by the first encoding unit 22 mentioned hereinabove.

An example of a possible implementation for step E6 is described hereinafter with reference to FIG. 10.

Step E6 makes it possible to generate encoded data D1 representative of the current digital hologram Hₖ.

These encoded data D1 are transmitted, by the communication unit 30 of the encoding device 20 and via a communication network, to the decoding device 40 (step E8).

As an alternative, the encoded date D1 could be stored within the encoding device 20 (for example, for subsequent use in the case where the encoding device 20 and the decoding device 40 are a single and same electronic device).

In steps E10 to E14 now described, the digital hologram Hₖ of index k is used as a reference digital hologram for the differential encoding (i.e. in the form of a residue) of the digital hologram Hₖ₊₁ that follows the digital hologram Hₖ in the sequence of digital holograms.

In step E10, the prediction unit 24 determines a transformation Tₖ₊₁ (here a rigid transformation as already mentioned) on the basis of the reference digital hologram Hₖ and of the following digital hologram Hₖ₊₁, then determines a predicted digital hologram H′ₖ by transformation of the reference digital hologram Hₖ using the function (or symplectomorphism) χ associated, as explained hereinabove, to the transformation Tₖ₊₁ determined.

The transformation Tₖ₊₁ is for example determined by analysis of movement between the scene represented by the reference digital hologram Hₖ and the following digital hologram Hₖ₊₁, as proposed by the patent application WO 2021/004 797.

The representation W′ₖ of the predicted digital hologram H′ₖ (by means of second coefficients W′ₖ(ε)) is then determined from the representation Wₖ of the reference digital hologram Hₖ (by means of the first coefficients Wₖ(ε)) using the function χ associated with the transformation Tₖ₊₁ in accordance with what has been described hereinabove, i.e., with a simplified notation:

$${W}_{k}^{′} = {W}_{k} o χ + {\sum }_{n = 1}^{N} {λ}^{n} {P}_{n} .$$

where o is the function composition operator, λ is the recording wavelength of the digital holograms and Pₙ complex functions defined on the space-frequency domain D as explained hereinabove.

A coefficient associated with an element (x₀, y₀, η₀, ξ₀) and participating to the representation of the predicted digital hologram H′ₖ is thus determined using the formula:

$${W}_{k}^{′} = ( χ ( {x}_{0} , {y}_{0} , {η}_{0} , {ξ}_{0} ) ) + {\sum }_{n = 1}^{N} {λ}^{n} {P}_{n} ( {x}_{0} , {y}_{0} , {η}_{0} , {ξ}_{0} ) .$$

Thus, for determining a second coefficient W′ₖ(ε₀) associated with an element ε₀ formed by a first value x₀ relating to the first spatial parameter, a second value y₀ relating to the second spatial parameter, a third value no relating to the first frequency parameter and a fourth value ξ₀ relating to the second frequency parameter, we use in particular the first coefficient Wₖ associated with the image, by the function χ, of the element ε₀ formed by the first value x₀, the second value y₀, the third value no and the fourth value ξ₀.

According to the formula proposed hereinabove to calculate the coefficients W′ₖ(ε) representing the predicted digital hologram H′ₖ, we use a corrective term

$${\sum }_{n = 1}^{N} {λ}^{n} {P}_{n}$$

that depends on the wavelength λ of acquisition of the digital hologram. This corrective term being a sum of functions, in one possible alternative, a single term of this sum can be used as a corrective term when determining the coefficients W′ₖ(ε).

According to another alternative, in order to reduce processing times, the corrective term can be ignored; in this case, any second coefficient W′ₖ(ε₀) determined in step E10 and associated with an element ε₀ formed by a first value x₀ relating to the first spatial parameter, a second value y₀ relating to the second spatial parameter, a third value η₀ relating to the first frequency parameter and a fourth value ξ₀ relating to the second frequency parameter, is equal to the first coefficient Wₖ associated with the image, by the function χ, of the element ε₀ formed by the first value x₀, the second value y₀, the third value no and the fourth value ξ₀.

Moreover, it is also possible to obtain the coefficients W′ₖ(ε) by multiplying the expression given hereinabove (with or without using the corrective term), that then forms an intermediate value, by a space-frequency distribution function A with real values on the space-frequency domain D and variable in function only along the two frequency dimensions (i.e. there exists a function f with two variables such that Δ(x,y,η,ξ)=f(η,ξ) for any tuple (x,y,η,ξ)), for example to obtain an attenuation of the digital hologram in a certain direction.

This space-frequency distribution frequency is for example of the form:

$$Δ ( x , y , q , ξ ) = cos θ + sin θ \frac{- ξ}{\sqrt{1 - {η}^{2} - {ξ}^{2}}} \qquad [ Math . 34 ]$$

with θ a predetermined value linked to the direction of attenuation, and the general formula that gives the expression of the coefficients W′ₖ representing the predicted hologram H′ₖ is then:

$${W}_{k}^{′} = [ {W}_{k} o χ + {\sum }_{n = 1}^{N} {λ}^{n} {P}_{n} ] \cdot Δ .$$

The method then continues with a step E12 of decomposing the digital hologram Hₖ₊₁ into Gabor frames Wₖ₊₁.

This step is similar to step E4 carried out for the digital hologram Hₖ and makes it possible to obtain, in order to represent the digital hologram Hₖ₊₁, a set of coefficients (herein complex) Wₖ₊₁(ζ) respectively associated with elements ζ of the space-frequency domain D.

The method of FIG. 7 is continued by a step E14 of determining a residue eₖ₊₁ between the digital hologram Hₖ₊₁ and the predicted digital hologram H′ₖ, here by difference between the digital hologram Hₖ₊₁ and the predicted digital hologram H′ₖ. This step is here carried out by the residue determination unit 26.

In practice, this difference is made between the coefficients Wₖ₊₁(ζ) representing the digital hologram Hₖ₊₁ and the coefficients W′ₖ(ζ) representing the predicted digital hologram H′ₖ, and therefore, in a simplified form:

$${e}_{k + 1} = {W}_{k + 1} - {W}_{k}^{′}$$

More precisely, for all the elements & of the space-frequency domain D for which one at least of the coefficients Wₖ₊₁(ε) and W′ₖ(ε) is non-zero, the residue determination unit 26 determines a (complex) coefficient eₖ₊₁(ε) of the residue eₖ₊₁ by the operation:

$${e}_{k + 1} ( ε ) = {W}_{k + 1} ( ε ) - {W}_{k}^{′} ( ε )$$

The communication unit 30 can then transmit, in step E16, data D2, D3, D4 representative of the transformation Tₖ₊₁ and of the residue eₖ₊₁ to the decoding device 40 (via the above-mentioned communication network). As an alternative, these representative data could be stored in a memory of the encoding device 20 for subsequent use.

The data D2 representative of the transformation Tₖ₊₁ comprise values that characterise the transformation Tₖ₊₁, for example the values of the components of the vector defining the translation involved and the angle values defining the different rotations involved.

It is proposed to encode the residue eₖ₊₁ as follows for its transmission to the decoding device 40. As an alternative, the encoding method described hereafter with reference to FIG. 10 could be used.

Here the real part and the imaginary part of each of the coefficients eₖ₊₁(ε) are processed separately.

Images I_{i,j} are formed, which each gather the real part of the coefficients eₖ₊₁(ε) that are associated with elements, the first frequency parameter and the second frequency parameter of which are fixed.

In other words, a pixel in line p and column q of an image I_{i,j} has for value:

$${I}_{i , j} ( p , q ) = Re [ {e}_{k + 1} ( ( {x}_{p} , {y}_{p} , {η}_{i} , {ξ}_{i} ) ) ]$$

where Re[γ] designate the real part of the complex number γ and ηᵢ and ξⱼ are respectively the first frequency parameter and the second frequency parameter associated with the image I_{i,j}.

The sequence of images formed by the images I_{i,j} (when i and j vary in order to sweep all the pairs of first frequency parameter ηᵢ—second frequency parameter ξⱼ used in the representation) is then encoded by means of a video encoder (for example in accordance with a standard of the AVC or HEVC type).

The above-mentioned sequence of images can be formed by taking the images I_{i,j} in the following order: the different images I_{1,j} with j increasing, then the different images I_{2,j} with j decreasing, then the different images I_{3,j} with j increasing, etc.

The encoded data D3 produced by the encoding of the sequence of images I_{i,j} are sent to the decoding device 40 by the communication circuit 30.

In the same way, images J_{i,j} are formed, which each gather the imaginary part of the coefficients eₖ₊₁(ε) that are associated with elements, the first frequency parameter and the second frequency parameter of which are fixed.

In other words, a pixel in line p and column q of an image J_{i,j} has for value:

$${J}_{i , j} ( p , q ) = Im [ {e}_{k + 1} ( ( {x}_{p} , {y}_{p} , {η}_{i} , {ξ}_{i} ) ) ]$$

where Im[γ] designate the imaginary part of the complex number γ and ηᵢ and ξⱼ are respectively the first frequency parameter and the second frequency parameter associated with the image J_{i,j}.

The sequence of images formed by the images J_{i,j} (when i and j vary in order to sweep all the pairs of first frequency parameter ηᵢ—second frequency parameter ξⱼ used in the representation) is then encoded by means of a video encoder (for example in accordance with a standard of the AVC or HEVC type).

The above-mentioned sequence of images can be formed by taking the images J_{i,j} in the following order: the different images J_{i,j} with j increasing, then the different images J_{2,j} with j decreasing, then the different images J_{3,j} with j increasing, etc.

The encoded data D4 produced by the encoding of the sequence of images J_{i,j} are sent to the decoding device 40 by the communication circuit 30.

The method of FIG. 7 continues with a step E18 of incrementing (by one unit) the index k for processing the following digital hologram.

The method then comprises a step E20 in which the encoding device 20 determines if a reset of the differential encoding is required, i.e. whether the new digital hologram Hₖ₊₁ to be encoded has to be fully encoded (as in step E6) or can still be encoded by differential encoding.

The criterion to determine if a reset is necessary is for example a frequency criterion (in order to obtain a predetermined number of successive digital holograms encoded by differential encoding) or an error limitation criterion (by limiting to a predetermined threshold a measurement of error between the original digital hologram and the digital hologram reconstructed after decoding as explained in the following).

If the encoding device 20 determines in step E20 that a reset is necessary, the method continues (arrow P) with step E22 for a new incrementation of index k (by one unit) then loops to step E4 for processing the new digital hologram, now designated Hₖ.

If the encoding device 20 determines in step E20 that a reset is not necessary, the method continues (arrow N) with step E10 for a differential encoding of the new digital hologram Hₖ₊₁.

The decoding of the data transmitted by the encoding device 20 as explained hereinabove, in order to reconstruct the sequence of digital holograms, will now be described (still with reference to FIG. 7).

Upon receipt of the encoded data D1 representative of the digital hologram Hₖ, the first decoding unit 42 decodes the encoded data D1 (step E30) so as to obtain the coefficients Wₖ(ζ) forming the representation of the digital hologram Hₖ.

An example of a possible decoding method is described hereinafter with reference to FIG. 11.

The reconstruction unit 49 can then reconstruct the digital hologram Hₖ in step E32 on the basis of the coefficients Wₖ(ζ) decoded in step E30.

To do this, we use the inverse transformation of that used in step E4 to obtain the representation of the digital hologram. In the example described herein, we thus use the inverse transformation of that used to obtain the decomposition into Gabor frames.

The digital hologram Hₖ is thus here reconstructed according to formula [Math. 6] presented hereinabove (using the decoded coefficients Wₖ(ζ) as values in this

$${W}_{ψ}^{{Φ}^{D}}$$

in this equation).

The digital hologram Hₖ can then be rendered by means of a holographic rendering device (step E34). Such a holographic rendering device comprises for example a light modulator and a light source of wavelength λ. The digital hologram Hₖ is rendered by applying the values of the pixels of the digital hologram Hₖ to the pixels of the light modulator, respectively, and by illuminating the light modulator by means of the light source.

Later, upon receipt of the encoded data D2, D3, D4, the second decoding unit 44 decodes these data in step E40 so as to obtain the transformation Tₖ₊₁ and the residue eₖ₊₁.

The second decoding unit 44 determines the transformation Tₖ₊₁ from the encoded data D2, here from the values of the components of the vector defining the translation characteristic of the transformation Tₖ₊₁ and angle values defining the different rotations characteristic of the transformation T_{k+1.}

Moreover, the second decoding unit 44 reconstructs the sequence of images I_{i,j} from encoded data D3 and can therefore determine the respective real parts of the coefficients eₖ₊₁(ε) representing the residue e_{k+1.}

Likewise, the second decoding unit 44 reconstructs the sequence of images J_{i,j} from encoded data D4 and can therefore determine the respective imaginary parts of the coefficients eₖ₊₁(ε) representing the residue eₖ₊₁.

The second decoding unit 44 can hence determine the (complex) coefficients eₖ₊₁(ε), i.e. decoding the residue eₖ₊₁, from the data D3, D4 received from the encoding device 20.

Moreover, the prediction unit 46 can predict the predicted hologram H′ₖ in step E42 by transformation of a reference digital hologram, for example the digital hologram Hₖ decoded in step E30 or a digital hologram obtained during a previous passage in step E44 described hereinafter.

During this step E42, the coefficients W′ₖ(ε) of the predicted digital hologram H′ₖ are determined on the basis of coefficients Wₖ(ε) representing the reference digital hologram Hₖ and the transformation Tₖ₊₁ (decoded in step E40 on the basis of the data D2 received from the encoding device 20), according to a process identical to that used in step E10 described above and which will therefore not be described again. The determination of the predicted digital hologram H′ₖ during the decoding therefore also uses the function χ associated, as explained hereinabove, with the transformation Tₖ₊₁.

In step E44, the combination unit 48 can also obtain the decoded digital hologram Hₖ₊₁ by combination of residue eₖ₊₁ (decoded in step E40) and of the predicted digital hologram H′ₖ, here by summing (coefficient by coefficient) the residue eₖ₊₁ and the predicted digital hologram H′ₖ:

$${H}_{k + 1} = {H}_{k}^{′} + {e}_{k + 1} .$$

In other words, for any element ε of the space-frequency domain D corresponding to a coefficient in the representation of the residue eₖ₊₁ or the predicted digital hologram H′ₖ, the combination unit 48 determines the coefficient Wₖ₊₁(ε) associated with the element ε in the representation of the decoded digital hologram Hₖ₊₁ as follows:

$${H}_{k + 1} ( ε ) = {H}_{k}^{′} ( ε ) + {e}_{k + 1} ( ε ) .$$

The reconstruction unit 49 can then reconstruct the digital hologram Hₖ₊₁ in step E46 on the basis of the coefficients Wₖ₊₁(ε) obtained in step E44, in the same way as what has been done for the digital hologram Hₖ in step E32.

The digital hologram Hₖ₊₁ can the be rendered by means of the holographic rendering means (step E48), here by applying respectively the values of the pixels of the digital hologram Hₖ₊₁ to the pixels of the light modulator and by illuminating the light modulator by means of the light source.

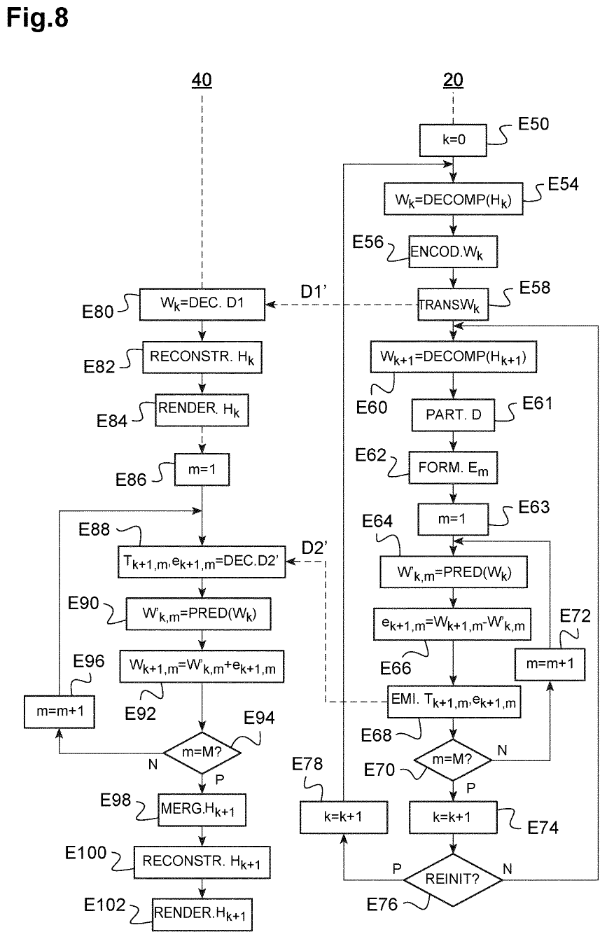

FIG. 8 shows an alternative embodiment of the method of FIG. 7 in which several objects Oₘ (here M objects O₁, O₂, . . . , O_{M}) are considered in the three-dimensional scene represented by the digital holograms. The method of FIG. 8 can also be implemented by the cooperation of the encoded device 20 and the decoding device 40.

The method of FIG. 8 also begins by initialising (for example to the value 0) an index k designating the digital hologram being processed (step E50).

The encoding device 20 then performs a step E54 of decomposing the current digital hologram Hₖ into Gabor frames Wₖ. This step E54 is identical to the step E4 described above with reference to FIG. 7 and will not be described in detail.

Step E54 thus makes it possible to obtain (here complex) coefficients Wₖ(ζ) respectively associated with elements Z of the space-frequency domain D and representing the current digital hologram Hₖ.

The encoding device 20 then proceeds to a step E56 of encoding of coefficients Wₖ(ζ) representing the digital hologram Hₖ. This encoding step is identical to step E6 described hereinabove and here carried out by the first encoding unit 22 mentioned hereinabove. This encoding step uses for example an encoding as exposed hereinafter with reference to FIG. 10. The encoding step E56 makes it possible to produce encoded data D1 representative of coefficients Wₖ(ζ).

In step E58, the communication unit 30 can then send the data D1′ representative of the coefficients Wₖ(ζ) to the decoding device 40. Step E58 is here identical to the above-described step E8.

The method then comprises a step E60 (identical to step E12 of the method of FIG. 7) for decomposing the digital hologram Hₖ₊₁ into Gabor frames Wₖ₊₁. This step E60 makes it possible to obtain, in order to represent the digital hologram Hₖ₊₁, a set of (here complex) coefficients Wₖ₊₁(ζ) respectively associated with elements 3 of the space-frequency domain D.

The method of FIG. 8 continues with a step E61 of partitioning the space-frequency domain D into a plurality of disjoint parts Pₘ respectively associated with the objects Oₘ.

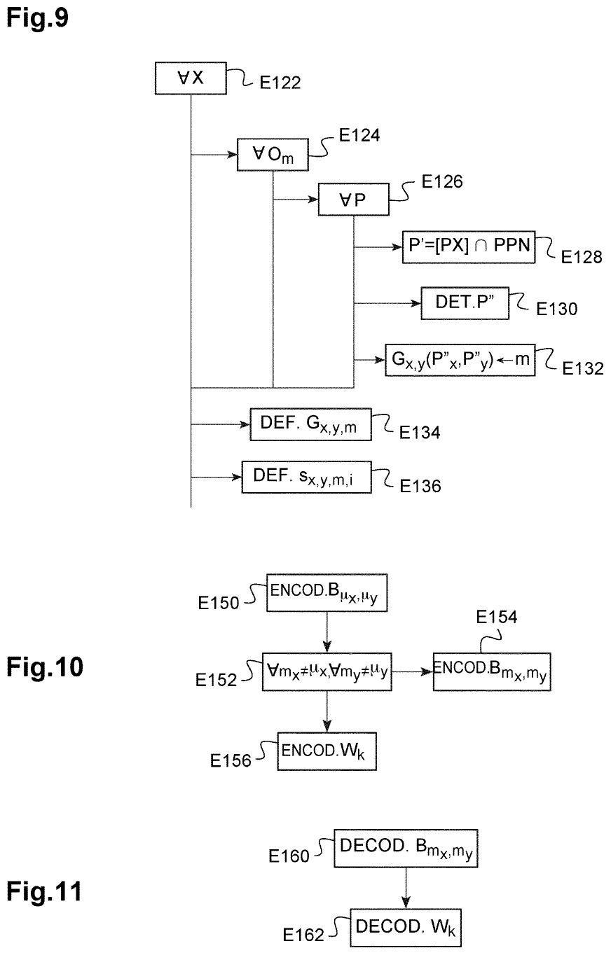

An example of method making it possible to obtain such a partition is given hereinafter with reference to FIG. 9.

The encoding device 20 can then form in step E62 disjoint sets Eₘ by gathering in a given set Eₘ the coefficients Wₖ₊₁(ζ) associated with elements ζ belonging to a part Pₘ of the space-frequency domain D associated with this given set Eₘ.

In other words, a coefficient Wₖ₊₁(ζ) belongs to a set Eₘ if and only if the element ζ belongs to part Pₘ.

The coefficients Wₖ₊₁(ζ) of a set Eₘ thus represent a partial digital hologram H_{k+1,m} which corresponds to the object Oₘ.

In the example described herein (and as explained hereinafter in the description of FIG. 9), it is proposed to determine as follows to which set Eₘ belongs a coefficient Wₖ₊₁(ζ) associated with an element ζ=(x,y,η,ξ) of the space-frequency domain D.

The frequency coordinates (η,ξ) are converted into spatial coordinates (pₓ,p_{y}) with:

$${p}_{x} = 1 / tan ( arcsin ( λ \cdot η ) ) and {p}_{y} = 1 / tan ( arcsin ( λ \cdot ξ ) ) ,$$

then it is determined to which sub-set G_{x,y,m} belongs the couple (pₓ,p_{y}), for example by calculating on which side of each line (s_{x,y,m},i, s_{x,y,m,i+1}) is the point (pₓ,p_{y}). (It is reminded that the sub-sets G_{x,y,m}, delimited by the segments [s_{x,y,m,i}, s_{x,y,m,i+1}] are defined by the implementation of the method described hereinafter with reference to FIG. 9 during step E61.)

The coefficient Wₖ₊₁(ζ) associated with the element ζ=(x,y,η,ξ) will then be allocated to the set Eₘ associated with sub-set G_{x,y,m}.

The method continues with a step E63 of initialising (here to the value 1) an index m designating the object Oₘ (and thus also the set Eₘ) being processed.

The prediction unit 24 then predicts in step E64 a partial predicted digital hologram H′_{k,m} by transformation of a partial reference digital hologram H_{k,m} defined by the coefficients Wₖ(χₘ(ζ)) associated with the elements χₘ(ζ) for ζ varying in the part Pₘ associated with the object Oₘ.

As in step E10 of the embodiment of FIG. 7, this step E64 uses a function χₘ associated with the transformation T_{k+1,m} associated with the object Oₘ in accordance with what has been described hereinabove for the symplectomorphism x. The transformation T_{k+1,m} is therefore determined here using an algorithm for estimating the motion of the object Oₘ. As already indicated, the solution proposed in the patent application WO 2021/004 797 can be used.

Here, the prediction unit 24 determines the coefficients W′_{k,m}(ε) of the partial predicted hologram H′_{k,m} as follows:

$${W}_{k , m}^{′} ( ε ) = {W}_{k , m} ( {χ}_{m} ( ε ) ) + {\sum }_{n = 1}^{N} {λ}^{n} {P}_{n} ( ε )$$

for the elements ε belonging to part Pₘ of the space-frequency domain D, i.e. so as to predict the coefficients Wₖ₊₁(ε) belonging to set Eₘ (these coefficients are denoted W_{k+1,m}(ε) hereinafter).

The residue determination unit 26 can then determine a partial residue eₖ₊₁,m between the partial digital hologram H_{k+1,m} and the predicted digital hologram H′_{k,m}, here by difference between the partial digital hologram H_{k+1,m} and the partial predicted digital hologram H′_{k,m}., i.e. for any element ε belong to part Pₘ of the space-frequency domain D (here for any coefficient W_{k+1,m} (ε) belonging to set Eₘ):

$${e}_{k + 1 , m} ( ε ) = {W}_{k + 1 , m} ( ε ) - {W}_{k , m}^{′} ( ε ) .$$

The communication unit 30 then transmits, in step E68, data D2′ representative of the transformation T_{k+1,m} and the partial residue e_{k+1,m}.

To obtain these data D2′, we use for example an encoding identical to that describe hereinabove for the encoding of the transformation Tₖ and the residue eₖ₊₁. In particular, according a possible embodiment, the partial residue e_{k+1,m} can be encoded by means of the encoding method described hereinafter with reference to FIG. 10.

The encoding device 20 then determines in step E70 if all the objects Oₘ have been processed, i.e. here if m=M.

If not (arrow N), the index m is incremented by 1 (step E72) and the method loops to step E64 described hereinabove.

If yes (arrow P), the method continues with step E74 described up to now.

A step E74, the index k is incremented by 1.

The method then comprises a step E76 (identical to step E20 described hereinabove) in which the encoding device 20 determines if a reset of the differential encoding is required, i.e. whether the new digital hologram Hₖ₊₁ to be encoded has to be fully encoded or can still be encoded by differential encoding.

Reference can be made to the description of step E20 as regards the criterion to determine if a reset is necessary.

If the encoding device 20 determines in step E76 that a reset is necessary, the method continues (arrow P) with step E78 for a new incrementation of index k (by one unit) then loops to step E54 for processing the new digital hologram, now designated Hₖ.

If the encoding device 20 determines in step E76 that a reset is not necessary, the method continues (arrow N) with step E60 for a differential encoding of the new digital hologram Hₖ₊₁.

The decoding of data D1′, D2′ transmitted by the encoding device 20 as explained hereinabove, in order to reconstruct the sequence of digital holograms, will now be described still with reference to FIG. 8.

The decoding method comprises a step E80 of decoding the data D1′ as received by the communication unit 50 so as to obtain the disjoint sets Eₘ and the coefficients Wₖ(ζ) contained in each of these disjoint sets Eₘ.

The reconstruction unit 49 can then reconstruct the digital hologram Hₖ in step E82 on the basis of all the coefficients Wₖ(ζ) decoded in step E80 (i.e. the coefficients contained in all the sets Eₘ). It can be observed that the information relating to the disjoint sets Eₘ are not used in this step, but will be used hereinafter.

This step E82 is similar to step E32 described in the description of FIG. 8 and will not be described in detail.

The digital hologram Hₖ can the be rendered in step E84 by means of a holographic rendering device of the same type as that used in step E34 described hereinabove.

The decoding of a digital hologram Hₖ₊₁ differentially encoded with respect to a reference digital hologram Hₖ (as for example the digital hologram decoded in step E80), here by means of the data D2′ mentioned hereinabove, will now be described.

The decoding device 20 transmits for example signalisation data to the decoding device 40 (within the data stream transmitted by the communication module 30 and received by the communication module 50) to indicate this differential encoding of the next digital hologram in the sequence. This signalisation data can for example indicate the number M of objects present in the three-dimensional scene.

The decoding device 40 then initialises an index m to 1 (step E86).

The decoding device 40 then decodes, in step E88, the data D2′ received so as to obtain the transformation T_{k+1,m} and the partial residue e_{k+1,m}.

The prediction unit 46 can then predict, in step E90, the partial predicted digital hologram H′_{k,m} on the basis of the transformation T_{k+1,m} and of the partial reference digital hologram H_{k,m} defined by the coefficients Wₖ(χₘ(ε)) such that the element ε belongs to part Pₘ of the space-frequency domain D associated with the current object Oₘ. The processing operations carried out during this step E90 are identical to those carried out during step E64 during the encoding and will therefore not be described again. These processing operations makes it possible to obtain the coefficients W′_{k,m}(ε) representing the partial predicted digital hologram H′_{k,m}.

The combination unit 48 then obtains the partial digital hologram H_{k+1,m} by combination of the partial residue e_{k+1,m} (decoded in step E88) and of the partial predicted digital hologram H′_{k,m}, here by summing (coefficient by coefficient) the partial residue e_{k+1,m} and the partial predicted digital hologram H′_{k,m}:

$${H}_{k + 1 , m} = {H}_{k , m}^{′} + {e}_{k + 1 , m} .$$

In other words, for any element ε belonging to part Pₘ of the space-frequency domain D, the combination unit 48 determines the coefficient W_{k+1,m} (ε) associated with the element ε in the representation of the partial digital hologram H_{k+1,m} as follows:

$${W}_{k + 1 , m} ( ε ) = {W}_{k , m}^{′} ( ε ) + {e}_{k + 1 , m} ( ε ) .$$

The decoding device 40 then determines in step E94 if all the objects Oₘ have been processed, i.e. here if m=M.

If not (arrow N), the index m is incremented by 1 (step E96) and the method loops to step E88 described hereinabove.

If yes (arrow P), the method continues with step E74 by a step of merging all the coefficients W_{k+1,m}(ε) obtained during the different passages in step E92 and that represent (together) the decoded digital hologram Hₖ₊₁.

The reconstruction unit 49 can then reconstruct the digital hologram Hₖ₊₁ in step E100 on the basis of the coefficients merged in step E98, in the same way as what has been done for the digital hologram Hₖ in step E82.

The digital hologram Hₖ₊₁ can the be rendered by means of the holographic rendering device (step E102), here by applying respectively the values of the pixels of the digital hologram Hₖ₊₁ to the pixels of the light modulator and by illuminating the light modulator by means of the light source.

A method for partitioning the space-frequency domain D will now be described with reference to FIG. 9.

In the example described here, the space-frequency domain D is partitioned into parts Pₘ by partitioning, for each point of the digital hologram of coordinates (x,y), a set M_{x,y} containing all the couples (u,v) of frequency variables used in the representation of the digital hologram concerned, i.e. all the directions associated with these couples (u,v), or, which is equivalent, by partitioning part of a plane PPN parallel to the plane of the digital hologram, as described hereinafter.

The method thus starts by initiating a loop that covers all the points X of coordinates (x,y) of the digital hologram (step E122).

For each point X, the method initiates, in step 124, a loop that covers all the objects Oₘ from the object furthest from the plane of the hologram to the nearest object.

In certain cases of application, the objects, their positions and their shapes are known. That is the case, for example, when the digital hologram concerned has been constructed from a representation of the three-dimensional scene comprising these objects.

In other cases of application, the objects are reconstructed from the digital hologram concerned, using for example the techniques described in the article “Comparative analysis of autofocus functions in digital in-line phase-shifting holography”, E. S. R. Fonseca, P. T. Fiadeiro, M. Pereira and A. Pinheiro, Appl. Opt., AO, vol. 55, n° 27, p. 7663-7674 September 2016.

For each object Oₘ, the method initiates, in step E126, a loop that covers all the points P of the object Oₘ. It is supposed that the object is discretised over a finite number of points and the coordinates of the current point P are denoted (Pₓ, P_{y}, P_{z}). For each point P of the object Oₘ, it is determined, in step E128, the point P′ at the intersection of the segment [PX] and the plane PPN parallel to the (reference) plane of the digital hologram. Here, we take for plane PPN, the plane of equation z=1 (it being reminded that the reference plane is the plane of equation z=0).

Here, the coordinates of point P′ are thus ((Pₓ−x)/P_{z}, (P_{y}−y)/P_{z}, 1).

Then, it is determined, in step E130, a point P″ of the digital hologram of coordinates (P″ₓ,P″_{y}) such that no other point on the digital hologram is closer to point P′ than point P″.

In step E132, an element of a matrix G_{x,y} of the same dimensions as the digital hologram can then be filled in: the element of coordinates (P″ₓ, P″_{y}) in the matrix G_{x,y} is fixed to the value m (corresponding to the current object Oₘ). If this element has already been filled at a previous passage in step E132, the previous value is overwritten (i.e. replace by the current value of the variable m).

Once the above-mentioned loops on the objects Oₘ and there points P are finished, the method goes to step E134 in which sets G_{x,y,m} are defined: Gₘ={(x′,y′): G_{x,y}(x′,y′)=m}. In other words, a given set G_{x,y,m} is the set of couples (x′,y′) for which the element of coordinates (x′,y′) in the matrix G_{x,y} is equal to m. The sets G_{x,y,m} are therefore disjoint sets and each correspond (thanks to the perspective projection of centre (x,y,0) made in step E128) to the set of directions in which the object Oₘ concerned is located (from the point of coordinates (x,y,0)), i.e. the set of couples of frequency coordinates (u,v) of the set M_{x,y} associated with these directions.

The definition of sets G_{x,y,m} thus amounts to a partitioning of set M_{x,y} and thus, when this has been done for all the couples (x,y), to a partitioning the space-frequency domain D into parts Pₘ, with the following equivalence: (x,y,u,v) belongs to Pₘ if and only if the couple (1/tan (arcsin (λ.u)), 1/tan (arcsin (λ.v))) belongs to G_{x,y,m}.

The method continues with a step E136 of determining, for each set G_{x,y,m}, a set of segments [s_{x,y,m,i},s_{x,y,m,i+1}] delimiting the set G_{x,y,m}. For example, the set of points bordering set G_{x,y,m} (i.e. neighbours with a point that does not belong to set G_{x,y,m}) is scanned and each of these points is used as one of the points s_{x,y,m,i} that define a limit of a segment [s_{x,y,m,i}, s_{x,y,m,i+1}].

After step E136, the method possibly loops to step E124 for processing a new point X of the digital hologram, until all the points of the digital hologram have been processed.

A method for encoding coefficients associated respectively with elements of the space-frequency domain D and used to represent a digital hologram will now be described with reference to FIG. 10. In the example described here, it is the encoding of coefficients Wₖ(ζ) representing a digital hologram Hₖ so as to obtain data D1 representative of this digital hologram Hₖ. In the context described hereinabove, this method is implemented by the first encoding unit 22 of the encoding device 20. As an alternative, however, this method could be used to encode other types of coefficients, for example the coefficients forming the above-mentioned residue eₖ₊₁.

As indicated hereinabove, the digital hologram Hₖ is represented here by a plurality of coefficients Wₖ(ζ) respectively associated with elements Z that belong to a mesh ∧ of the space-frequency domain D (see the above equation [Math 5] for the definition of mesh ∧). It is reminded that coefficients Wₖ(ζ) are complex numbers.

In the following, let us denote nₓ (nₓ integer varying from 1 to Nₓ) the indexes respectively associated with the values xₙ_{ₓ} of the first spatial parameter used in the representation of the digital hologram Hₖ, n_{y} (n_{y} integer varying from 1 to N_{y}) the indexes respectively associated with the values yₙ_{_{y}} of the second spatial parameter used in this same representation, mₓ (mₓ integer varying from 1 to Mₓ) the indexes respectively associated with the values ηₘ_{ₓ} of the first frequency parameter used in the representation and m_{y} (m_{y} integer varying from 1 to M_{y}) the indexes respectively associated with the values ξₘ_{_{y}} of the second frequency parameter used in the representation.

To facilitate the presentation that follows, blocks Bₘ_{ₓ}_{,m}_{_{y}} are defined as follows (for all quadruplets (nₓ, n_{y}, mₓ, m_{y}) used in the representation):
Bₘ_{ₓ}_{,m}_{_{y}}(nₓ, n_{y})=Wₖ((xₙ_{ₓ}>yₙ_{_{y}}, ηₘ_{ₓ}, ξₘ_{_{y}})) if the representation of Hₖ comprises a coefficient associated with the element (xₙ_{ₓ}, yₙ_{_{y}}, ηₘ_{ₓ}, ξₘ_{_{y}})
Bₘ_{ₓ}_{,m}_{_{y}}(nₓ, n_{y})=0 otherwise.

In other words, each block Bₘ_{ₓ}_{,m}_{_{y}} comprises (all) the coefficients associated with the elements having ηₘ_{ₓ} as the value of the first frequency parameter and ξₘ_{_{y}} as the value of the second frequency parameter, organised as a matrix as a function of the respective values of the first spatial parameter and the second spatial parameter.

The element defined by the position (nₓ, n_{y}) in the block Bₘ_{ₓ}_{,m}_{_{y}} is zero when no coefficient is associated with the element (xₙ_{ₓ}, yₙ_{_{y}}, ηₘ_{ₓ}, ξₘ_{_{y}}) in the representation of the digital hologram Hₖ.

The method of FIG. 10 starts with a step E150 of encoding the positions of the non-zero coefficients in a first block B_{μ}_{_{y}}_{,μ}_{_{y}} with here μₓ=1 and μ_{y}=1.

The definition of a block Bₘ_{ₓ}_{,m}_{_{y}}(as proposed here) is a particular way to associated in a predefined manner a set of positions (in the block) with the coefficients respectively associated with the different tuples of the form (x,y,ηₘ_{ₓ}, ξₘ_{_{y}}).

In practice, the position used for the encoding can be defined in an ordered sequence of the coefficients within the block Bₘ_{ₓ}_{,m}_{_{y}} concerned (here, block B_{μ}_{ₓ}_{,μ}_{_{y}}=B_{1,1}).

For that purpose, for the block Bₘ_{ₓ}_{,m}_{_{y}} concerned, coefficients of the block are ordered, for example, by raster scan order: the coefficients Bₘ_{ₓ}_{,m}_{_{y}}(1, n_{y}) are ordered in ascending order of index n_{y} relating to the second spatial parameter (n_{y} increasing from 1 to N_{y}), then the coefficients Bₘ_{ₓ}_{,m}_{_{y}}(2, n_{y}) in descending order of index n_{y} (n_{y} decreasing from N_{y} to 1), then again by ascending order of index n_{y} for coefficients Bₘ_{ₓ}_{,m}_{_{y}}(3, n_{y}), etc.

It is here proposed to encode the positions of the non-zero coefficients B_{μ}_{ₓ}_{,μ}_{_{y}}(nₓ, n_{y}) by means of indicative data representing the difference between the positions of two successive non-zero coefficients in the ordered sequence of coefficients (except for the first coefficient whose position will be for example encoded in absolute value).

Thus, for example, the positions of the non-zero coefficients c₁, c₂, c₃, c₄ in a sequence (0 c1 0 0 c2 c3 0 0 0 c4 0 0 0) will be encoded by the numbers: 2, 3, 1, 4, where 2 represents the position of the first non-zero coefficient c₁, 3 the difference between the position of the second non-zero coefficient c₂ and the position of the first non-zero coefficient c₁, 1 the difference between the position of the third non-zero coefficient c₃ and the position of the second non-zero coefficient c₂ and 4 the difference between the position of the fourth non-zero coefficient c₄ and the position of the third non-zero coefficient c₃.

Hereinafter, the data indicative of the positions of the non-zero coefficients in block B_{μ}_{ₓ}_{,μ}_{_{y}} are denoted D11.

The method then initiates a loop in step E152 so as to process all blocks Bₘ_{ₓ}_{,m}_{_{y}} other than block B_{μ}_{ₓ}_{,μ}_{_{y}}.

The different blocks Bₘ_{ₓ}_{,m}_{_{y}} can for example be processed in a raster scan order by considering the set of blocks Bₘ_{ₓ}_{,m}_{_{y}} as elements of a frame: the blocks B_{1,m}_{_{y}} are processed in ascending order of index m_{y} (from 2 to My in the example described here), then blocks B_{2,m}_{_{y}} in descending order of index m_{y} (here from My to 1), then the blocks B_{3,m}_{_{y}} by ascending order of index m_{y} (here from 1 to My), then the blocks B_{4,m}_{_{y}} by ascending order of index m_{y} (here from 1 to My), etc.

Regardless of the order in which the blocks are processed, in the following we note B′ₘ_{ₓ}_{,m}_{_{y}} the block processed immediately before the current block Bₘ_{ₓ}_{,m}_{_{y}} (wherein this block B′ₘ_{ₓ}_{,m}_{_{y}} can be the block B_{μ}_{ₓ}_{,μ}_{_{y}} during the processing of the first block Bₘ_{ₓ}_{,m}_{_{y}} designated by the loop initiated in step 152, or a block previously processed in step E152 described below).

For all blocks Bₘ_{ₓ}_{,m}_{_{y}} other than block B_{μ}_{ₓ}_{,μ}_{_{y}} (and here in the processing order defined hereinabove), the method performs in step E154 the encoding of the positions of the non-zero coefficients of this block Bₘ_{ₓ}_{,m}_{_{y}} (current block).

In the example described herein, it is proposed to encode on the one hand (within data D12) the positions of the non-zero coefficients in the previous block B′ₘ_{ₓ}_{,m}_{_{y}} for which the corresponding coefficient in the current block Bₘ_{ₓ}_{,m}_{_{y}} is zero, and on the other hand (within data D13) the positions of the non-zero coefficients in the current block Bₘ_{ₓ}_{,m}_{_{y}} for which the corresponding coefficient in the previous block B′ₘ_{ₓ}_{,m}_{_{y}} is zero.

In other words, data D12 represent the positions of the coefficients that “disappear” from the representation upon passing from the previous block B′ₘ_{ₓ}_{,m}_{_{y}} to the current block Bₘ_{ₓ}_{,m}_{_{y}}, whereas data D13 represent the positions of the coefficients that “appear” in the representation upon passing from the previous block B′ₘ_{ₓ}_{,m}_{_{y}} to the current block Bₘ_{ₓ}_{,m}_{_{y}}.

Therefore, data D13 designate at least one position associated with a non-zero coefficient in the current block Bₘ_{ₓ}_{,m}_{_{y}}, without however designating at least one other position associated with another non-zero coefficient when this other position is already indicated by indicative data encoded (within the framework of the position encoding in the previous block B′ₘ_{ₓ}_{,m}_{_{y}}) for another pair of respective values of the first frequency parameter and the second frequency parameter.

Besides, data D12 designate positions (each) corresponding to a zero coefficient in the current block Bₘ_{ₓ}_{,m}_{_{y}}, but for which the corresponding coefficient was non-zero in the previously processed block B′ₘ_{ₓ}_{,m}_{_{y}}, these positions being thus indicated in indicative data encoded for another pair of respective values of the first frequency parameter and the second frequency parameter.

Therefore, no data is encoded in the data stream when, for a given position, the coefficients of the current bloc and the previous block are both zero, or both non-zero.

The positions encoded in step E154 are for example the absolute positions of the coefficients concerned within the ordered sequence (by raster scan order) defined hereinabove within each block Bₘ_{ₓ}_{,m}_{_{y}}.

The method then comprises a step E156 of encoding (non-zero) coefficients associated with the positions indicated by the indicative data D11, D12, D13.

These coefficients are for example encoded in the order of the processing operations carried out in steps E150 and E154, i.e. starting by the block B_{μ}_{ₓ}_{,μ}_{_{y}} (here block B_{1,1}) then by raster scan order within the blocks Bₘ_{ₓ}_{,m}_{_{y}}, and, within each block, in the raster scan order (described hereinabove in the context of step E150).

For the encoding of a given coefficient Wₖ((xₙ_{ₓ}>yₙ_{_{y}},ηₘ_{ₓ},ξₘ_{_{y}})), the real part of this coefficient is quantized and, on the other hand, the imaginary part of the coefficient is quantized, the quantized real part and the quantized imaginary part being then concatenated.

The quantifier used for quantification is, for example, a uniform scalar quantifier or a quantifier as described in the article “Exact global motion compensation for holographic video compression”, of Raees Kizhakkumkara Muhamad et al. in Applied Optics58, G204-G217 (2019).

In the example described here, the coefficient encoding in step E156 is performed after the position encoding of steps E150 and E154. As an alternative, the coefficient encoding could be interposed between position encoding steps: for example, encoding of the (non-zero) coefficients of a block Bₘ_{ₓ}_{,m}_{_{y}} could be performed after the encoding of the non-zero coefficient positions in this block Bₘ_{ₓ}_{,m}_{_{y}} as carried out is step E150 or in step E154.

All data obtained in the different encoding steps mentioned hereinabove (step E150, E154, E156) can further be encoded by an entropic encoder, for example an adaptive arithmetic encoder, in order to obtain the data D1 to be transmitted to the decoding device 40 (or, as an alternative, to be stored for latter decoding).

Finally, markers can be inserted between the different types of data (here, between data D11, data D12, data D13 and the real and imaginary parts of the quantized coefficients) in order to retrieve these data at the decoder. Other solutions can however be used, such as the use of a fixed length for the data representative of the real part and the imaginary parts of the coefficients, for example.

The stream of data D1 transmitted (from the encoding device 20 to the decoding device 40 in the context described hereinabove) to represent the digital hologram Hₖ thus comprises:
data D11 indicative of the positions which are associated, respectively, with non-zero coefficients within the block B_{μ}_{ₓ}_{,μ}_{_{y}} (i.e. from a set of the positions associated, in a predefined manner, with the coefficients which are associated, respectively, with the different tuples defined by value η_{μ}_{ₓ} for the first frequency parameter and by value ξ_{μ}_{_{y}} for the second frequency parameter);
then, successively for each of the other blocks Bₘ_{ₓ}_{,m}_{_{y}}, data D12, D13 indicative of the positions which are associated, respectively, with non-zero coefficients within the block Bₘ_{ₓ}_{,m}_{_{y}} concerned (i.e. from a set of positions associated, in a predefined manner, with the coefficients which are associated, respectively, with the different tuples defined by value ηₘ_{ₓ} for the first frequency parameter and by value ξₘ_{_{y}} for the second frequency parameter);
for each block, data representative of the coefficients which are associated, respectively, with the positions indicated by said indicative data relating to the block concerned.

As already indicated, for each block, the position of the coefficients used for the encoding can be defined within an ordered sequence of the coefficients within the block Bₘ_{ₓ}_{,m}_{_{y}} concerned, for example the already-presented raster scan order.

A method for decoding such a data stream, as implemented for example by the decoding device 40 the above-mentioned step E30, will now be described with reference to FIG. 11.

For each block Bₘ_{ₓ}_{,m}_{_{y}} defined hereinabove within the framework of the encoding method of FIG. 10, the decoding device (especially, the first decoding unit 42 in the context described with reference to FIG. 6) decodes, in step E160, the data indicatives of the positions associated with non-zero coefficients in the block Bₘ_{ₓ}_{,m}_{_{y}} concerned, i.e. from a set of positions associated, in a predefined manner (here by definition of the block), with the coefficients which are associated, respectively, with the different tuples whose first frequency coordinate is the value ηₘ_{ₓ} associated to index mₓ and whose second frequency coordinate is the value ξₘ_{_{y}} associated with index m_{y}.

The different blocks are for example transmitted (and thus present within the data stream) in a predefined order by convention between the encoding device 20 and the decoding device 40, in such a way that the already-mentioned raster scan order within the blocks arranged as a matrix of blocks. As an alternative, complementary data could be placed in the header of the data relating to a block Bₘ_{ₓ}_{,m}_{_{y}} and indicate parameters designating the block Bₘ_{ₓ}_{,m}_{_{y}} concerned (these parameters being for example the indexes mₓ and m_{y} of the block concerned).

In the case of block B_{μ}_{ₓ}_{,μ}_{_{y}} (here, block B_{1,1}), the data D11 indicative of the positions of the non-zero coefficients (here within an ordered sequence of coefficients of block B_{μ}_{ₓ}_{,μ}_{_{y}}) represent a difference between a position associated with a non-zero coefficient and another position associated with another non-zero coefficient, as explained in the description of the encoding method.

In the case of blocks Bₘ_{ₓ}_{,m}_{_{y}} other than block B_{μ}_{ₓ}_{,μ}_{_{y}}, data D12, D13 indicative of the non-zero coefficient positions (here within an ordered sequence of coefficients of block B_{μ}_{ₓ}_{,μ}_{_{y}}) designate either the positions of the zero coefficients in the current block Bₘ_{ₓ}_{,m}_{_{y}} whereas the coefficient at the same position was non-zero in the block B′ₘ_{ₓ}_{,m}_{_{y}} previously decoded (data D12), or the positions of the non-zero coefficients in the current block Bₘ_{ₓ}_{,m}_{_{y}} whereas the coefficient at the same position was zero in the block B′ₘ_{ₓ}_{,m}_{_{y}} previously decoded (data D13).

Therefore, data D13 designate at least one position associated with a non-zero coefficient without designating at least one other position associated with another non-zero coefficient when this other position has been indicated by indicative data decoded in relation with another block i.e. for another pair of respective values of the first frequency parameter and the second frequency parameter (this pair of values being associated with the coefficients forming the other block).

When the data indicative of the positions of the non-zero coefficients have been decoded for a given block Bₘ_{ₓ}_{,m}_{_{y}}, the decoding device 40 (precisely here the first decoding unit 42) can decode the coefficients respectively associated with the positions indicated by these indicative data.

The decoding device 40 thus fins the non-zero coefficients Bₘ_{ₓ}_{,m}_{_{y}}(nₓ,n_{y}), i.e the non-zero coefficients Wₖ((xₙ_{ₓ} yₙ_{_{y}}, nₘ_{ₓ}, ξₘ_{_{y}})).

By scanning all the blocks Bₘ_{ₓ}_{,m}_{_{y}} (for which the data are successively transmitted in the data stream), the decoding device 40 thus obtains all the non-zero coefficients Wₖ of the representation of the digital hologram Hₖ.

It can be noticed, as already indicated within the framework of the encoding method of FIG. 10, that the decoding device 40 can receive all the data indicative of the position of the non-zero coefficients for all the blocks Bₘ_{ₓ}_{,m}_{_{y}}, then the coefficients associated with these positions, or, as an alternative, considering successively the different blocks Bₘ_{ₓ}_{,m}_{_{y}}, the data indicative of the positions of the non-zero coefficients of this block and the coefficients associated with these positions.

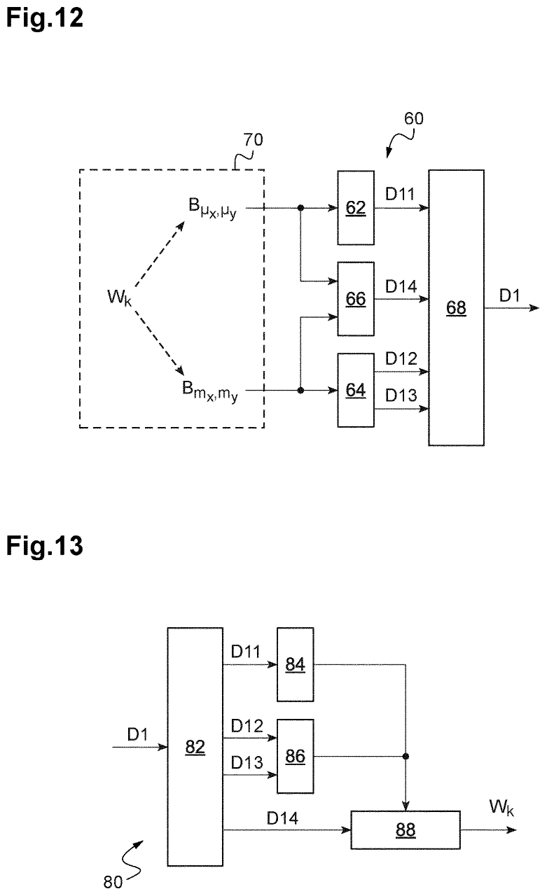

An example of encoding device 60 in accordance with the teachings of the invention will now be described with reference to FIG. 12.

It may be an encoding device such as the encoding device 20 described hereinabove with reference to FIG. 5, in which case the modules described hereinafter belong to the first encoding unit 22 mentioned hereinabove.

The encoding device 60 is for example made in the form of an electronic device comprising a processor (such as a microprocessor); in this case, each of the modules described hereinafter can be implemented due to the execution, by this processor, of computer program instructions stored within the encoding device (for example, in a memory 70 of this encoding device). However, as an alternative, at least one of the modules described hereinafter can be made by means of a dedicated electronic circuit, for example an application specific integrated circuit.

The encoding device 60 comprises an initial-block processing module 62, a subsequent-block processing module 64, a coefficient processing module 66 and a finalisation module 68.

The encoding device 60 is thus able to implement the method described hereinabove with reference to FIG. 10, here when the processor of the encoding device 60 performs certain computer program instructions stored in the memory 70 of the encoding device and already mentioned hereinabove.

As explained hereinabove with reference to FIG. 10, the coefficients to be encoded by the encoding device 60 are coefficients respectively associated with tuples each formed by a first spatial parameter xₙ_{ₓ}, a second spatial parameter yₙ_{_{y}}, a first frequency parameter ηₘ_{ₓ} and a second frequency parameter ξₘ_{_{y}}.

As already indicated, we describe here the case in which these coefficients are coefficients Wₖ that form (on their own) a representation of a digital hologram. As an alternative, these coefficients could represent a digital hologram in combination with other elements, for example in the case where the coefficients define a residue, such as the residue eₖ₊₁ mentioned hereinabove.

The modules 62, 64, 66, 68 can access the memory 70 of the encoding device 60 in which are stored the coefficients Wₖ to be encoded and can thus process these coefficients as blocks B_{μ}_{ₓ}_{,μ}_{_{y}}, Bₘ_{ₓ}_{,m}_{_{y}}, as will be explained now.

The initial-block processing module 62 is designed to encode data D11 indicative of the positions of the non-zero coefficients within the block B_{μ}_{ₓ}_{,μ}_{_{y}} de coefficients Wₖ defined hereinabove, by encoding of difference between two successive positions associated with non-zero coefficients.

This block B_{μ}_{ₓ}_{,μ}_{_{y}} gathers the coefficients which are associated with the tuples whose first frequency parameter is equal to nux and whose second frequency parameter is equal to ξμ_{y}.

The subsequent-block processing module 64 is designed to encode data D12, D13 indicative of the positions of the non-zero coefficients within each of the blocks Bₘ_{ₓ}_{,m}_{_{y}} of coefficients Wₖ defined hereinabove, by encoding of the positions of the non-zero coefficients in the previous block B′ₘ_{ₓ}_{,m}_{_{y}} for which the corresponding coefficient in the current block Bₘ_{ₓ}_{,m}_{_{y}} is zero (data D12), and by encoding of the positions of the non-zero coefficients in the current block Bₘ_{ₓ}_{,m}_{_{y}} for which the corresponding coefficient in the previous block B′ₘ_{ₓ}_{,m}_{_{y}} is zero (data D13).

As explained hereinabove, for each couple (mₓ, m_{y}), the block Bₘ_{ₓ}_{,m}_{_{y}} gathers the coefficients Wₖ which are associated with the tuples whose first frequency parameter is equal to μₘ_{ₓ} and thus the second frequency parameter is equal to ξₘ_{_{y}}.

The coefficient processing module 66 is designed to encode the non-zero coefficients Wₖ, i.e. the coefficients Wₖ whose positions are indicated in the indicative data D11, D12, D13, according to a predefined order, for example by raster scan order, within all the blocks B_{μ}_{ₓ}_{,μ}_{_{y}}, Bₘ_{ₓ}_{,m}_{_{y}}, and within each block, by raster scan order among the coefficients Wₖ of the block. The encoded coefficients are denoted D14.

The finalising module 68 proceeds to the entropic encoding of data D11, D12, D13, D14 and/or inserts markers between the different types of data in order to obtain the data D1 to be transmitted.

An example of decoding device 80 in accordance with the teachings of the invention will now be described with reference to FIG. 13.

It may be a decoding device such as the decoding device 40 described hereinabove with reference to FIG. 6, in which case the modules described hereinafter belong to the first decoding unit 42 mentioned hereinabove.

The decoding device 80 is for example made in the form of an electronic device comprising a processor (such as a microprocessor); in this case, each of the modules described hereinafter can be implemented due to the execution, by this processor, of computer program instructions stored within the decoding device (for example, in a memory of this decoding device). However, as an alternative, at least one of the modules described hereinafter can be made by means of a dedicated electronic circuit, for example an application specific integrated circuit.

The decoding device 80 comprises an analysis module 82, an initial-block construction module 82, a subsequent-block construction module 84 and a coefficient decoding module 88.

The decoding device 80 is thus able to implement the method described hereinabove with reference to FIG. 11, here when the processor of the decoding device 80 performs certain computer program instructions stored in the memory of the decoding device and already mentioned hereinabove.

The analysis module 82 receives the data D1 and retrieve therein the different data D11, D12, D13, D14, for example using the above-mentioned markers. The analysis module 82 can possibly carry out a step of entropic decoding (when an entropic encoding has been performed within the above-described finalisation module 68).

The initial-block construction module 84 is designed to decode the data D11 representative of the differences between two successive positions associated with non-zero coefficients within the block B_{μ}_{ₓ}_{,μ}_{_{y}} of coefficients Wₖ, so as to obtain the positions of the non-zero coefficients within this block B_{μ}_{ₓ}_{,μ}_{_{y}}. It is reminded in this respect that the coefficients of the block B_{μ}_{ₓ}_{,μ}_{_{y}} are ordered in a predefined manner, for example a raster scan order.

There are various possible solutions for storing the positions of these non-zero coefficients. For example, the initial-block construction module 84 initializes to zero the elements of a table corresponding to the coefficients in the form Wₖ(x,y, μₓ, μ_{y}), then sets to a predefined non-zero value (for example, the value 1) the elements corresponding to the coefficients indicated as non-zero based on data D11. (When the coefficients are complex numbers, this can be done for the real part of the coefficients and for the imaginary part of the coefficients.)

For each couple (mₓ, m_{y}) (different from (μₓ, μ_{y}), the subsequent-block construction module 86 is designed to obtain the positions of the non-zero coefficients Wₖ within this bloc Bₘ_{ₓ}_{,m}_{_{y}} by decoding on the one hand the data D12 indicative of the positions of the non-zero coefficients in the previously processed block B′ₘ_{ₓ}_{,m}_{_{y}} which the corresponding coefficient in the current block Bₘ_{ₓ}_{,m}_{_{y}} is zero and the data D13 indicative of the positions of the non-zero coefficients in the current block Bₘ_{ₓ}_{,m}_{_{y}} for which the corresponding coefficient in the previously processed block B′ₘ_{ₓ}_{,m}_{_{y}} is zero.

Here again, there are various possible solutions for storing the positions of these non-zero coefficients. For example, the subsequent-block construction module 86 initializes to zero the elements of a table corresponding to the coefficients in the form Wₖ(x,y, mₓ, m_{y}), then sets to a predefined non-zero value (for example, the value 1) the elements corresponding to the coefficients indicated as non-zero based on data D12 and D13. (When the coefficients are complex numbers, this can be done for the real part of the coefficients and for the imaginary part of the coefficients.)

The coefficient decoding module 88 is designed to decode the data D14 representing the (non-zero) coefficients Wₖ associated, respectively, to the positions indicated by the data D11, D12, D13.

As indicated hereinabove, the coefficients Wₖ are encoded within data D14 in a predefined order, so that the coefficient decoding module 88 can associate each decoded coefficient with a position of a non-zero coefficient, and thus retrieve the value of a coefficient Wₖ((xₙ_{ₓ} yₙ_{_{y}}, ηₘ_{ₓ}, ξₘ_{_{y}})).

For example, within the scope of the implementation option described below, the coefficient decoding module 88 runs through the above-mentioned tables in a predefined order corresponding to the coefficient encoding order, then, when a coefficient is decoded, the value of the decoded coefficient is allocated to the next element of predefined non-zero value in the table being processed.

1. A method for encoding a set of coefficients (Wₖ) participating in a representation of a digital hologram (Hₖ) by being respectively associated with tuples, each of the tuples comprising a first spatial parameter, a second spatial parameter, a first frequency parameter and a second frequency parameter,
the method comprising, for at least one pair of respective values of the first frequency parameter and the second frequency parameter:
encoding position data indicative of positions that are associated, respectively, with non-zero coefficients from a set of positions associated, in a predefined manner, with the coefficients that are associated, respectively, with the different tuples defined by said pair of values of the first frequency parameter and the second frequency parameter;
encoding the coefficients that are associated, respectively, with the positions indicated by said position data.

2. The encoding method according to claim 1, wherein at least one component of said position data represents a difference between a said position associated with one of the non-zero coefficients and another said position associated with another one of the non-zero coefficients.

3. The encoding method according to claim 1, wherein said position data designate at least one said position associated with one of the non-zero coefficients without designating at least one other said position associated with another one of the non-zero coefficients and indicated by the position data encoded for another pair of respective values of the first frequency parameter and the second frequency parameter.

4. The encoding method according to claim 1, wherein the coefficients associated with different ones of the tuples defined by said pair of values of the first frequency parameter and the second frequency parameter are ordered in a predefined manner into an ordered sequence of coefficients and wherein the position data associated with a given said non-zero coefficient indicates the position of the given non-zero coefficient in said ordered sequence of coefficients.

5. The encoding method according to claim 4, wherein, in the coefficient encoding step, the non-zero coefficients are encoded in the order defined by the ordered sequence.

6. A method for decoding a set of coefficients (Wₖ) participating in a representation of a digital hologram by being respectively associated with tuples, each of the tuples comprising a first spatial parameter, a second spatial parameter, a first frequency parameter and a second frequency parameter,
the method comprising, for at least one pair of respective values of the first frequency parameter and the second frequency parameter:
decoding position data indicative of positions that are associated, respectively, with non-zero coefficients from a set of positions associated, in a predefined manner, with the coefficients that are associated, respectively, with the different tuples comprising said pair of values of the first frequency parameter and the second frequency parameter;
decoding the coefficients that are associated, respectively, with the positions indicated by said position data.

7. The decoding method according to claim 6, wherein at least one component of said position data represents a difference between a said position associated with one of the non-zero coefficients and another said position associated with another one of the non-zero coefficients.

8. The decoding method according to claim 6, wherein said position data designate at least one said position associated with one of the non-zero coefficients without designating at least one other said position associated with another one of the non-zero coefficients and indicated by the position data decoded for another pair of respective values of the first frequency parameter and the second frequency parameter.

9. A device for encoding a set of coefficients (Wₖ) participating in a representation of a digital hologram by being respectively associated with tuples, each of the tuples comprising a first spatial parameter, a second spatial parameter, a first frequency parameter and a second frequency parameter, comprising:
a first encoding module configured to encode, for at least one pair of respective values of the first frequency parameter and the second frequency parameter, position data indicative of positions that are associated, respectively, with non-zero coefficients from a set of positions associated, in a predefined manner, with the coefficients that are associated, respectively, with the different tuples defined by said pair of values of the first frequency parameter and the second frequency parameter;
a second encoding module configured to encode the coefficients that are associated, respectively, with the positions indicated by said position data.

10. A device for decoding a set of coefficients (Wₖ) participating in a representation of a digital hologram by being respectively associated with tuples, each of the tuples comprising a first spatial parameter, a second spatial parameter, a first frequency parameter and a second frequency parameter, comprising:
a first decoding module configured to decode, for at least one pair of respective values of the first frequency parameter and the second frequency parameter, position data indicative of positions that are associated, respectively, with non-zero coefficients from a set of positions associated, in a predefined manner, with the coefficients that are associated, respectively, with the different tuples comprising said pair of values of the first frequency parameter and the second frequency parameter;
a second decoding module configured to decode the coefficients that are associated, respectively, with the positions indicated by said position data.

11. A data stream representing a set of coefficients (Wₖ) participating in a representation of a digital hologram by being respectively associated with tuples, each of the tuples comprising a first spatial parameter, a second spatial parameter, a first frequency parameter and a second frequency parameter, the data stream comprising, for at least one pair of respective values of the first frequency parameter and the second frequency parameter:
position data indicative of positions that are associated, respectively, with non-zero coefficients from a set of positions associated, in a predefined manner, with the coefficients that are associated, respectively, with the different tuples defined by said pair of values of the first frequency parameter and the second frequency parameter;
data representative of the coefficients that are associated, respectively, with the positions indicated by said position data.

12. A non-transitory computer-readable medium on which is stored a computer program comprising instructions that perform the method according to claim 1 when executed by a processor.

13. The encoding method according to claim 2, wherein the coefficients associated with different ones of the tuples defined by said pair of values of the first frequency parameter and the second frequency parameter are ordered in a predefined manner into an ordered sequence of coefficients and wherein the position data associated with a given said non-zero coefficient indicates the position of the given non-zero coefficient in said ordered sequence of coefficients.

14. The encoding method according to claim 3, wherein the coefficients associated with different ones of the tuples defined by said pair of values of the first frequency parameter and the second frequency parameter are ordered in a predefined manner into an ordered sequence of coefficients and wherein the position data associated with a given said non-zero coefficient indicates the position of the given non-zero coefficient in said ordered sequence of coefficients.

15. A non-transitory computer-readable medium on which is stored a computer program comprising instructions that perform the method according to claim 2 when executed by a processor.

16. A non-transitory computer-readable medium on which is stored a computer program comprising instructions that perform the method according to claim 3 when executed by a processor.

17. A non-transitory computer-readable medium on which is stored a computer program comprising instructions that perform the method according to claim 4 when executed by a processor.

18. A non-transitory computer-readable medium on which is stored a computer program comprising instructions that perform the method according to claim 5 when executed by a processor.

19. A non-transitory computer-readable medium on which is stored a computer program comprising instructions that perform the method according to claim 6 when executed by a processor.

20. A non-transitory computer-readable medium on which is stored a computer program comprising instructions that perform the method according to claim 7 when executed by a processor.
